(19) United States
(12) Patent Application Publication
(10) Pub. No.: US 2004/0107436 A1
(43) Pub. Date: Jun. 3, 2004

(54) Digital broadcast signal distribution system and subscriber terminal

(75) Inventor: Masayuki Ishizaki, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/720,445

(22) Filed: Nov. 25, 2003

(30) Foreign Application Priority Data
Nov. 29, 2002 (JP) 2002-348888

(51) Int. Cl. H04N 7/16; H04N 7/025; H04N 7/10

(52) U.S. Cl. 725/36; 725/32; 725/146; 725/147

(57) ABSTRACT

A digital broadcast signal distribution system includes subscriber terminals each of which includes a distribution plan storage for retaining channel distribution plans, one representing distribution setting information of each of the plural distribution centers; a distribution center discriminating section for discriminating the one distribution center that has created a digital broadcast distribution signal received in the subscriber terminal; and a receiving section for changing, if the one distribution center is discriminated not to be a predetermined distribution center, NIT information of the first-named digital broadcast distribution signal based on the channel distribution plans of the one distribution center and the predetermined distribution center, and receiving the digital broadcast distribution signal. Whereupon the system can always distribute a good digital broadcast distribution signal and can be constructed at a low cost.

### BACKGROUND OF THE INVENTION

1. Field of the Invention

The present invention relates to a digital broadcast signal distribution system preferably used to distribute a digital broadcast distribution signal for a CATV (Community Antenna Television) broadcasting to subscribers and to a subscriber terminal preferably used in the digital broadcast signal distribution system.

2. Description of the Related Art

Analog broadcasting which provides subscribers with various services in a conventional CATV broadcasting system transmits a broadcast signal (image/voice signal) representing a single channel using a bandwidth of 6 MHz.

In accordance with recent improvements in digitalized technology based on a computer technique, digitalized broadcasting system has been enhanced. A digital broadcasting system can transmit a broadcast signal representing a number of programs to be broadcast on a number of channels, using a single analog-transmission bandwidth (6 MHz), so that it is possible to realize a multi-channel program distribution that effectively utilizes frequency resources.

Accompanying drawing FIG. 26 schematically shows a conventional digital broadcast signal distribution system. A conventional digital broadcast signal distribution system 1′ in FIG. 26 includes a plurality of local stations 14′, each of which is connected to two or more subscriber homes 12′ through CATV transmission cables 13′. A CATV transmission cable 13′ is exemplified by an HFC (hybrid fiber/coax).

Each local station 14′ includes a receiving antenna 11′ and functions as a head end that sends out signals received therein and VTR signals to CATV transmission cables 13′. In each local station 14′ the receiving antenna 11′ receives a digital broadcast distribution signal, provided by a program information provider, in the form of electric waves or of waves and then the received digital broadcast distribution signal is distributed to the subscriber homes 12′ downstream of the local station 14′ through CATV transmission cables 13′.

A non-illustrated digital set-top box (STB; a subscriber terminal) is installed at each subscriber home 12′. Responsive to subscriber's channel selection from an input device such as a remote controller (not shown), the STB turns to the selected channel and receives a broadcast distribution signal distributed from the upstream local station 14′ through a CATV transmission cable 13′.

Hereinafter is a description of a succession of procedural steps for selection of a program channel at a CS (Communication Satellite) receiver (STB) in a conventional digital broadcast signal distribution system with reference to flow diagram of an accompanying drawing FIG. 27 (steps A10 to A70).

When a subscriber (a subscriber home 12′) selects a desired service (a program) using a remote controller for a CS receiving unit (step A10), the CS receiving unit receives an NIT (Network Information Table) in a TS (Transport Stream) being received from a transponder (step A20) and obtains TS-ID of a TS including a service ID (S-ID) of the selected program and a carrier frequency (a transmission channel, a stream) of the TS (step A20).

The CS receiving unit determines whether or not a frequency change is required, in other words, whether or not a frequency of the currently-received stream is identical to a carrier frequency of stream including the selected service, in order to receive the selected service (program) (step A30).

If the result of the determination is positive, namely no frequency change is required, (Yes route in step A30), the CS receiving unit obtains a PAT (Program Association Table) from the TS (step A50) and further obtains the PMT (program map table) associated with the selected program based on the obtained PAT (step A60). On the other hand, if the result of the determination is negative (No route in step A30), the CS receiving unit turns to the transmission channel of the frequency (turning) (step A40) and proceeds to step A50.

The PMT designates a PID (Packet Identification) of each stream of video, voice, data and the like of the selected service. The CS receiving unit obtains, on the basis of the contents of the PMT, PIDs of packets required to give the selected program images and/or sound.

The CS receiving section filters and then receives (extracts) video and/or voice streams (a program element signal), PIDs of which are designated by the PMT (step A70). After performing a decoding process on the video and/or voice streams, the CS receiving unit sends these streams to a connected television (not shown) so that the subscriber can view the selected program.

The following references relate to the prior art of the present invention.

Reference #1: Japanese Patent Application Laid-Open (KOKAI) Publication No. HEI 11-275549 (Pages 3-4, FIGS. 1 and 2);

Reference #2: Japanese Patent Application Laid-Open (KOKAI) Publication No. 2001-128138 (Pages 3-4, FIGS. 1, 3, 5, 6, and 11); and

Reference #3: Japanese Patent Application Laid-Open (KOKAI) Publication No. 2002-158987 (Pages 4-7, FIGS. 1, 6, 20 and 21).

In such a conventional digital broadcast signal distribution system, a program selection process takes a long time because of retrieving and obtaining a TS based on NIT, PMT, PAT and other information and then extracting of video and/or voice streams associated with the designated service ID. In a known manner to solve the above problem, each STB retains a channel map table, in which each service (program) is correlated with associated S-ID, NW-ID, TS-ID and local center distribution channel (center frequency for distribution from the local center), shown in an accompanying drawing FIG. 28 beforehand so that video and/or voice streams corresponding to a selected program are rapidly obtained each time a subscriber (a subscriber home 12′) selects a channel.

FIG. 28 shows an example of a channel map table used in a conventional digital broadcast signal distribution system. Such a channel map table is a list including information of channels to be distributed to subscribers in a local area and is created on the basis of a channel distribution plan set for the local station that manages the local area. A channel map table is stored in a memory or the like of each STB beforehand.

In order to receive digital broadcast signals from a satellite in a good state, a CATV local station 14′ and a distribution center preferably use receiving antennas 11′ having a large diameter, but a diameter size of a receiving antenna 11′ installable therein is limited. Additionally, some installation locations of a receiving antenna 11′ are affected by weather, such as rain or other reasons, so that a good digital broadcast signal from a satellite cannot be received.

It is possible to avoid occurrence of at least momentary image disruption by performing parallel transmission of a broadcast signal from a satellite, utilizing a modulation manner insusceptible to rain or the like. However, subscribers wish to receive a broadcast signal in a good state at all times. For this reason, CATV agencies demand that image signal distribution always be in a good state in order to improve service to the subscribers.

A center station and CATV local station 14′ have to guard against a head-end failure and satellite-signal deterioration and demand a double head-end system.

However, since digital CATV facilities are much more expensive than analog broadcasting facilities, digital CATV facilities for each CATV agency and a double head-end system may cause a large burden on each CATV agency.

Digital signals are distributed through cables by various known methods: the pass-through method, transmodulation method, and the ReMux method. The pass-through method transmits digital signals, received by a cable station, downstream through a cable without modifying the signals, and has two types: one does not change the frequencies of the received signals and transmits the signal to a CATV network; and the other changes the frequencies of the signals to frequencies for CATV transmission and then transmits the signal to a CATV network. In the ReMux method, a cable station receives an analog broadcast signal and a digital broadcast signal in a unit of a program and reprograms the signals and then digitally transmits the reprogrammed signal. The transmodulation method receives a digital broadcast signal, modulates the received signal to be suitable for CATV communication utilizing 64 QAM modulating, and sends out the signal.

Since digital CATV broadcasts a wide variety of programs within limited channel resources, CATV agencies preferably select and transmit programs desired (to be enjoyed) by subscribers. Therefore, the ReMux method (program selection multiplex method) is the most suitable considering that a CATV agency selects programs to be distributed to subscribers. Nevertheless, the ReMux method requires center systems (distribution centers) that are more expensive than those required for other methods.

The Ministry of Posts and Telecommunications (present Ministry of Public Management, Home Affairs, Posts and Telecommunications) issued an analysis report entitled “Tactics to advance cable televisions and an accompanying ideal situation of future cable television” in May of 1999, which says it is now time to advance cable television in order to enhance the life of the public, while the communication infrastructure becomes more familiar to them.

Further, the report says that some CATV agencies of an MSO (Multiple Systems Operator) and an urban-area communicable system can digitalize the broadcasting system by themselves but equipment investment for the digitalization would be an extremely large burden to the agencies. As one solution, the report suggests that distribution centers are connected into a network to share digital head ends.

In line with the suggestion, a number of CATV agencies (local CATV agencies) may cooperate to configure Head Ends (HEs) shared by the agencies, or a CATV agency with a large capital may configure digital distribution centers (center stations) and may distribute digital signals to affiliated local CATV agencies so that it is possible to reduce equipment investment cost per agency.

Alternatively, in a back-up system in which local stations, each of which includes a broadcast signal receiving unit and manages a number of center stations, are communicably connected to one another through optical fibers or the like (a backup line), if one or more of the center stations are in a poor reception state of a broadcast signal, the same broadcast signal that is received another center station has good reception may be distributed to the center stations in a poor reception state.

However, in a conventional digital broadcast signal distribution system, each center station distributes a broadcast signal to the downstream local stations 14′ and the downstream subscribers based on a channel distribution plan peculiar to the center station, and STBs installed in the downstream subscriber homes store a channel map table corresponding to the channel distribution plan of the upstream center station. Therefore, if a STB receives a broadcast signal distributed from a center station other than the upstream center station without changing the signal, the STB cannot receive a program desired by the subscriber using the channel map table stored in the STB.

Namely, in order to receive a program on the basis of a broadcast signal from a center station other than the upstream center station, a STB cannot utilize a channel map table to deal with the received signal and has to retrieve and obtain a TS on the basis of an NIT, a PMT and a PAT to extract streams of video, voice and other data associated with a selected service ID whereupon a process for receiving a program problematically takes a long time.

As a solution, center stations and local stations may use a same channel plan. But CATV agencies do not utilize a common cable transmission frequency bandwidth, that is, one agency utilizes a bandwidth of 450 MHz while another utilizes that of 770 MHz. Further, digital broadcasting distribution channels have to be standardized using void channels of analog broadcasting (local broadcasting) provided by the individual local station. For this reason, it is difficult in practice to utilize a common channel plan among the center stations and the local stations.

As another solution, each center station and each local station may change NIT information of a broadcast distribution signal received from a center station other than the upstream center station so that each STB can receive a program from the broadcast distribution signal using the channel map table retained in the STB. In this case, each center and each station require an NIT changing unit and a 64 QAM modulator that are expensive and such facility costs may be excessive for CATV agencies.

### SUMMARY OF THE INVENTION

The foregoing problems in view, it is an object to provide a digital broadcast signal distribution system and a subscriber terminal for always providing subscribers with a broadcast signal of high quality, reducing the facility costs for the system.

To attain the object of the present invention, as a first generic feature, there is provided a digital broadcast distribution signal distribution system comprising: two or more distribution centers, communicably connected to one another through a communication line, each of the distribution centers for distributing a digital broadcast distribution signal, which has been created based on program information received in each of the distribution centers, to subscribers through a CATV (Community Antenna Television) network, for sending the digital broadcast distribution signal to another of the distribution centers and for receiving a digital broadcast distribution signal from another of the distribution centers; and subscriber terminals, each for receiving a digital broadcast distribution signal distributed from one of the distribution centers through the CATV network so that a subscriber views a program, each of the distribution centers including a signal replacement section for replacing the first-named digital broadcast distribution signal created based on the program information received in each of the distribution centers with the second-named digital broadcast distribution signal, which each of the distribution centers received from another of the distribution centers, and each of the subscriber terminals including a distribution plan storage for retaining channel distribution plans, one representing distribution setting information of the first-named digital broadcast distribution signal of each of the distribution centers, a distribution center discriminating section for discriminating the one distribution center that has created the third-named digital broadcast distribution signal, which is received in each of the subscriber terminals, and a receiving section for changing, if the one distribution center is discriminated not to be a predetermined distribution center, NIT information of the third-named digital broadcast distribution signal based on the channel distribution plans of the one distribution center and the predetermined distribution center, and receiving the third-named digital broadcast distribution signal.

As a preferable feature, the digital broadcast signal distribution may further comprise a local station, communicably connected to one of the distribution centers, for sending the third-digital broadcast distribution signal from the last-named one distribution center to subscribers downstream of the local station without changing at least PSI/SI (Program Specific Information/Service Information) of the third digital broadcast distribution signal. As another preferable feature, the signal replacement section in each of the distribution centers may replace the first-named digital broadcast distribution signal with the second-named digital broadcast distribution signal in accordance with a reception state of the first digital broadcast distribution signal at the distribution center.

As an additional preferable feature, the CATV network may include an optical fiber through which the third-named digital broadcast distribution signal is distributed to each of the subscriber terminals. As a further preferable feature, analog transmission may be performed on the third-named broadcast distribution signal while being distributed to each of the subscriber terminals in the CATV network.

As a still further preferable feature, the communication line that communicably connects the distribution centers may be a ring network.

As a still further preferable feature, the first-named digital broadcast distribution signal and the second-named digital broadcast distribution signal of each of the distribution centers may be sent and received through the communication line via Internet Protocol (IP).

As a still further preferable feature, each of the subscriber terminals may further include a distribution plan obtaining section for obtaining the channel distribution plans that are to be stored in the distribution plan storage.

As a second generic feature, there is provided a subscriber terminal for receiving a digital broadcast distribution signal from one of a plurality of distribution centers, each of which creates a digital broadcast distribution signal based on program information received from a provider, through a CATV (Community Antenna Television) network so that a subscriber views a program, the subscriber terminal comprising: a distribution plan storage for retaining channel distribution plans, one representing distribution setting information of each of the plural distribution centers; a distribution center discriminating section for discriminating the one distribution center that has created the first-named digital broadcast distribution signal received in the subscriber terminal; and a receiving section for changing, if the one distribution center is discriminated not to be a predetermined distribution center, NIT information of the first-named digital broadcast distribution signal based on the channel distribution plans of the one distribution center and the predetermined distribution center, and receiving the first-named digital broadcast distribution signal.

As a preferable feature, the subscriber terminal may further include a distribution plan obtaining section for obtaining the channel distribution plans that are to be stored in the distribution plan storage.

As another preferable feature, the distribution plan obtaining section may obtain the channel distribution plans through the CATV network.

As an additional preferable feature, each of the channel distribution plans may be distributed in the form of an Entitlement Management Message (EMM) or an Entitlement Control Message (ECM); and the distribution plan obtaining section may obtain each of the channel distribution plans from the EMM or the ECM.

As a further preferable feature, the distribution plan obtaining section may be communicably connected to a local station through a public communication line and may obtain the channel distribution plans through the public communication line.

As a still further preferable feature, the distribution plan obtaining section may be a recording medium reading section for reading the channel distribution plans from at least one recording medium in which the channel distribution plans are stored.

As a further preferable feature, the distribution center discrimination section may discriminate the one distribution center based on a toll agency identification code.

As a further preferable feature, the distribution center discrimination section may discriminate the one distribution center based on an agency code allocated by a Certification Authority (CA). As a further preferable feature, the distribution center discrimination section may discriminate the one distribution center based on a broadcast service type switching code (a network ID) or a service ID (S-ID) for a program selection, which broadcast service type switching code or service ID is input by an operator.

As a further preferable feature, the channel distribution plans may be stored in the distribution plan storage when the subscriber terminal is installed.

The digital broadcast signal distribution system and the subscriber terminal of the present invention ensure the following advantages:

(1) A subscriber terminal stores distribution setting information, as channel distribution plans, of the digital broadcast distribution signal created in each of the distribution centers and, if the one distribution center that has created the digital broadcast distribution signal received in the subscriber terminal is discriminated not to be a predetermined distribution center, NIT information of the received digital broadcast distribution signal based on the channel distribution plans of the one distribution center and the predetermined distribution center, and receiving the received digital broadcast distribution signal. For example, if a distribution center is in a poor reception state, it is possible for the digital broadcast signal distribution system to obtain program information that is of good reception quality and provide subscribers with good quality information.

(2) There is no requirement, as a program selection operation, to retrieve and obtain a TS on the basis of an NIT, a PMT, a PAT and other information in order to extract streams of video, voice and other data associated with designated service ID each time an operator selects a program whereupon a program selection operation can be accomplished in a short time.

(3) Distribution centers and the local station do not require equipment for changing NIT information, so that the centers and the station can be realized at a low cost.

(4) Distribution centers and the local station do not require equipment for changing PSI/SI, so that the centers and station can be realized at a low cost.

(5) Since a digital broadcast distribution signal is distributed through an optical fiber in the CATV network, quality deterioration of the signal during distribution can be avoided and it is possible to distribute a digital broadcast distribution signal that is of high quality to subscribers.

(6) Analog transmission is performed on a digital broadcast distribution signal while being distributed to each subscriber in the CATV network, so that the digital broadcast signal distribution system can be constructed at a low cost.

(7) With a repeater for relaying a digital broadcast distribution signal in the CATV network, it is possible to distribute a high-quality digital broadcast distribution signal to distant subscriber terminals.

(8) The communication line that communicably connects said distribution centers is a ring network, whereupon the digital broadcast signal distribution system can be realized with ease, and even if an obstruction makes a part of the communication line incapable of communication, it is possible to continue communication using distribution centers on the other side, thereby improving reliability of the communication line.

(9) Since each subscriber terminal obtains channel distribution plans in various manners and stores the obtained channel distribution plans in the distribution plan storage, each subscriber terminal can set the latest channel distribution plans.

(10) It is possible for each subscriber terminal to surely obtain channel distribution plans from each distribution center through the CATV network; from EMMs or ECMs; through a public communication line; or from at least one recording medium in which the channel distribution plans are stored.

Other objects and further features of the present invention will be apparent from the following detailed description when read in conjunction with the accompanying drawings.

### BRIEF DESCRIPTION OF THE DRAWINGS

FIG. 1 is a diagram schematically showing a functional configuration of a digital broadcast signal distribution system according to a first embodiment of the present invention;

FIG. 2 is a diagram showing an example of a configuration of the digital broadcast signal distribution system of FIG. 1;

FIG. 3 is a flow diagram illustrating a succession of procedural steps of replacement of a digital broadcast distribution signal in a signal replacement section of a shared digital center in the digital broadcast signal distribution system of FIG. 1;

FIG. 4 is a block diagram schematically showing the digital broadcast signal distribution system of FIG. 1;

FIG. 5 is a diagram showing a relationship between a shared digital center and a local station in the digital broadcast signal distribution system of FIG. 1;

FIGS. 6 and 7 are block diagrams respectively showing distribution manners of signals at a shared digital center in the digital broadcast signal distribution system of FIG. 1;

FIG. 8 is a table showing an example of distribution channels of BS digital broadcast distribution signals at a particular shared digital center in the digital broadcast signal distribution system of FIG. 1;

FIG. 9 is a table showing an example of a part of a channel distribution plan of a shared digital center in the digital broadcast signal distribution system of FIG. 1;

FIGS. 10 and 11 are block diagrams respectively showing distribution manners of signals at a local station in the digital broadcast signal distribution system of FIG. 1;

FIGS. 12(a) and 12(b) are tables, for comparison, respectively showing channel distribution plans of a shared digital center and a local station in the digital broadcast signal distribution system of FIG. 1;

FIG. 13 is a block diagram schematically showing a STB (a subscriber terminal) in the digital broadcast signal distribution system of FIG. 1;

FIG. 14 is a block diagram schematically showing another STB (a subscriber terminal) in the digital broadcast signal distribution system of FIG. 1;

FIGS. 15 and 16 are diagrams respectively showing examples of frequency division in line with each CATV channel service;

FIG. 17 is a diagram explaining in-band data transmission manner;

FIG. 18 is a diagram explaining out-of-band data transmission manner;

FIGS. 19(a) and 19(b) are diagrams respectively showing examples of a channel map table representing channel distribution plans in the digital broadcast signal distribution system of FIG.

FIG. 20 is a table showing a relationship between channel distribution plans of a local center in question and channel distribution plans of a broadcast distribution signal being received in a STB in the digital broadcast signal distribution system of FIG. 1;

FIG. 21 is a flow diagram illustrating a succession of procedural steps of selection of a program at a STB in the digital broadcast signal distribution system of FIG. 1;

FIG. 22 is a diagram illustrating an example of an EMM section format for BS access control, which section includes a toll agency identification code;

FIGS. 23, 24 and 25 are diagrams respectively illustrating examples of information tables concerning an agency code used for access control;

FIG. 26 is a block diagram schematically showing a conventional digital broadcast signal distribution system;

FIG. 27 is a flow diagram illustrating a succession of procedural steps of selection of a program channel at a CS (Communication Satellite) receiver (STB) in a conventional digital broadcast signal distribution system; and

FIG. 28 is a diagram illustrating an example of a channel map table in a conventional digital broadcast signal distribution system.

### DESCRIPTION OF THE PREFERRED EMBODIMENTS

A preferred embodiment of the present invention will now be described with reference to the accompanying drawings.

First Embodiment:

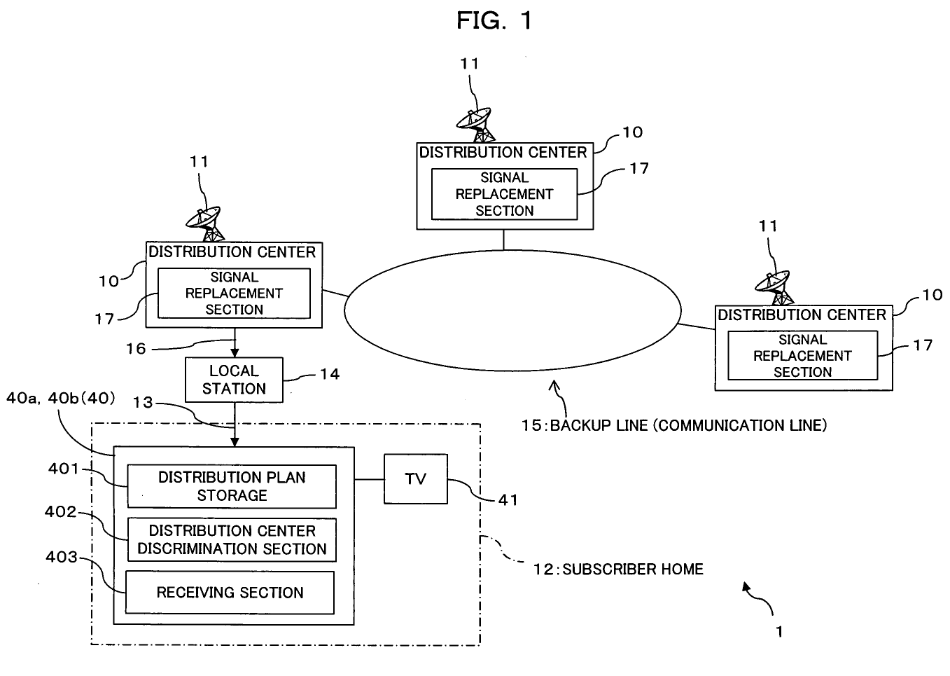

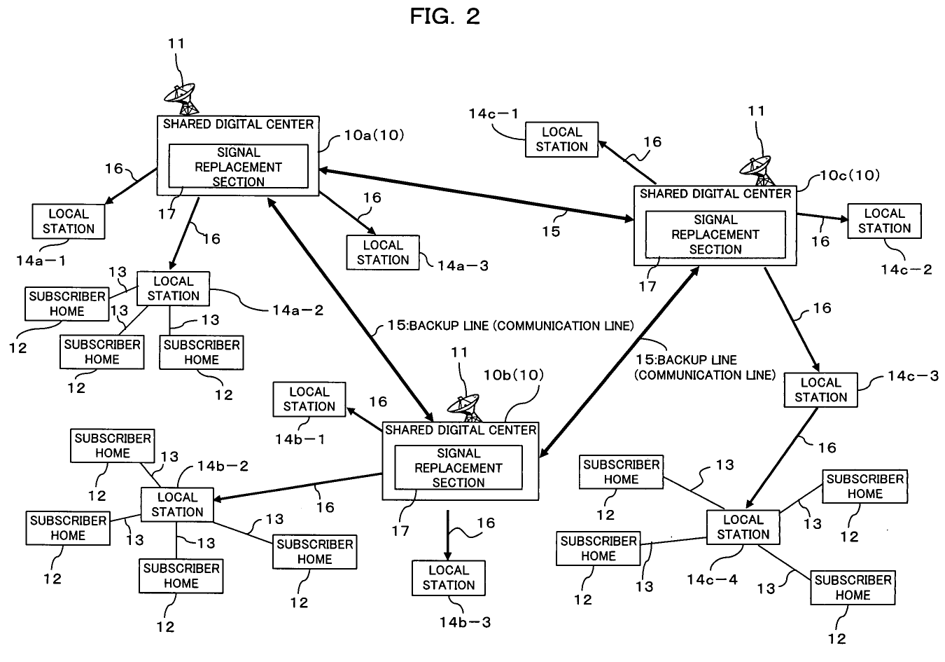

FIG. 1 shows a functional configuration of a digital broadcast signal distribution system according to a first embodiment of the present invention; FIG. 2 shows an example of a configuration of the digital broadcast signal distribution system of FIG. 1.

The digital broadcast signal distribution system 1 is a broadcast distribution system for digitized CATV (Community Antenna Television) and includes, as shown in FIGS. 1 and 2, distribution centers 10 (10a, 10b, and 10c), local stations 14, subscriber homes 12, a backup line (communication line) 15, first transmitting cables (a CATV network) 16 and second transmitting cables (a CATV network) 13.

In the digital broadcast signal distribution system 1 shown in FIG. 2, a plurality (three in the drawing) of shared digital centers 10a, 10b, and 10c are communicably connected to one another through the backup line 15, and a number of local stations 14 are connected to each of the shared digital centers through first transmitting cables 16 (e.g., three local stations 14 are connected to the shared digital center 10a). Further, a number of subscriber homes 12 are connected to each one of the local stations 14 through the second transmitting cables 13 (e.g., three subscriber homes 12 are connected to a local station 14a-2). Hereinafter, the digital broadcast signal distribution system 1 shown in FIG. 2 is assumed to be the first embodiment of the present invention.

Reference number 10a, 10b or 10c is used when a particular shared digital center has to be specified among these three centers in FIG. 2 while an arbitrary shared digital center is represented by reference number 10.

A shared digital center 10 receives program information (a digital broadcast distribution signal) from a program provider (not shown) via a non-illustrated Broadcasting Satellite (BS), a Communication Satellite (CS) and/or a wave, and distributes a broadcast distribution signal (the digital broadcast distribution signal) to subscribers. Each shared digital center 10 has a receiving antenna 11 and sends program information, which has been received by the receiving antenna 11, to downstream local stations 14 through first transmitting cables 16.

Each shared digital center 10 may directly distribute a broadcast distribution signal to, in addition to downstream local stations 14, subscriber home 12 to which the shared digital center 10 is connected through a communication line (e.g., a second transmitting cable 13 or the like) exemplified by a HFC (Hybrid Fiber/Coax). In order to directly distribute a broadcast signal to a subscriber 12, a shared digital center 10 has a function for serving as a head end (an originating point).

If a shared digital center 10 distributes a broadcast distribution signal to a subscriber home 12, the shared digital center 10 changes a modulation manner for satellite digital signals and also distributes, to the subscriber homes 12, transmission factors (a network infrastructure type, a modulation manner, a symbol rate, etc.) called an NIT (Network Information Table) of MPEG-TS (Motion Picture Group-Transport Stream) and carrier information such as a channel distribution plan.

Further, a shared digital center 10 is communicably connected to other shared digital centers 10 through the backup line (communication line) 15 so that a broadcast distribution signal which any one of the shared digital centers 10 has received can be sent to the remaining shared digital centers 10 through the backup line 15. Namely, the digital broadcast signal distribution system 1 of the present invention includes a backup line system in which, if a particular shared digital center 10 has poor reception of program information from a satellite, the particular shared digital center 10 replaces the program information with program information received from another station that has good reception. As shown in FIGS. 1 and 2, the backup line system takes the form of a ring network.

Communication among shared digital centers 10 and between a shared digital center 10 and a local station 14 is carried out by using IP transmission on the basis of Internet Protocol (IP). IP transmission will be the main technology for transmission networks in the near feature. Each shared digital center 10 and each local station 14 may respectively distribute broadcast distribution signals to local stations 14 and subscriber homes 12 respectively by using IP multicast.

Each shared digital center 10 receives program information from a satellite or the like using a receiving antenna 11. For this purpose, each shared digital center 10 has an input frequency selection function (serving as a tuner) and a demodulation function.

The input frequency selection function receives program information distributed by a satellite or the like and the demodulation function demodulates the received program information. The demodulation function also creates a signal indicating a reception state of program information from a satellite in the shared digital center 10 in question. On the basis of the created signal, the shared digital center 10 notifies downstream local stations 14 and subscriber homes 12 of a current reception state in the form of reception state information. The reception state information is indicated by three combinations of two digits “00” “01” and “10” respectively, representing good, standard, and poor states.

Each shared digital center 10 includes a signal replacement section 17 to determine a reception state of program information in the shared digital center 10 in question and selectively replace, in accordance with a determined reception state, with program information received from another shared digital center 10 through the backup line 15. Specifically, the signal replacement section 17 determines a current reception state of the center in question on the basis of reception state information; if the center has poor reception (reception state information: “10”) because of bad weather for example, the signal replacement section 17 requests another shared digital center 10 to distribute a corresponding broadcast distribution signal. On the other hand, if another shared digital center 10 requests the shared digital center 10 in question to distribute the broadcast distribution signal, the shared digital center 10 in question sends the broadcast distribution signal to the other shared digital center 10 through backup line 15.

When a shared digital center 10 has poor reception (in a poor reception state) of program information, the shared digital center 10 issues a signal distribution request to other shared digital centers 10 in a predetermined order. In the illustrated example, if shared digital center 10a has poor reception of program information, the shared digital center 10a issues a signal distribution request to other shared digital centers 10 in the order of the shared digital center 10b and the shared digital center 10c.

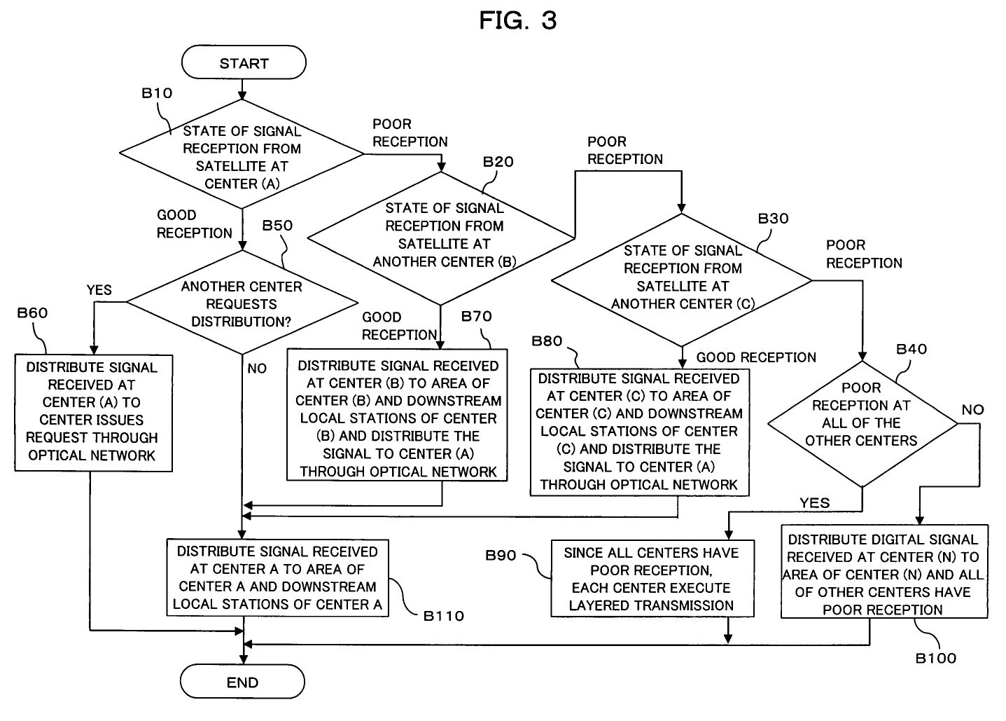

Here, signal replacement performed by the signal replacement section 17 in the shared digital center 10a of the digital broadcast signal distribution system 1 will now be described with reference to flow diagram FIG. 3 (steps B10 to B110).

The signal replacement section 17 determines reception state of program information from a satellite at the center in question (i.e., the shared digital center 10a based on receipt state information (step B10). If the center has good reception (in a good reception state) (the “good reception” route in step B10), the signal replacement section 17 determines whether or not other shared digital centers 10b and 10c request to distribute the broadcast distribution signal (step B50). If another shared digital center 10b or 1c requests distribution (Yes route in step B50), the signal replacement section 17 sends the broadcast distribution signal to the requesting shared digital center 10b or 10c through the backup line 15 (step B60).

If other shared digital centers 10b and 10c do not request distribution (No route in step B50), the signal replacement section 17 distributes the broadcast distribution signal to the downstream local stations 14 and the downstream subscriber homes 12 (step B110).

Conversely, if the shared digital center 10a a poor reception (the poor reception route in step B10), the signal replacement section 17 obtains reception state information of the shared digital center 10b to confirm a current reception state at the shared digital center 10b (step B20). At that time, if the shared digital center 10b has good reception (the “good reception” route in step B20), the shared digital center 10b distributes the broadcast distribution signal to the downstream local stations 14 and concurrently sends the signal to the shared digital center 10a through the backup line 15 (step B70). Then the procedural steps proceed to step B110.

If the shared digital center 10b also has poor reception (the “poor reception” route in step B20), the signal replacement section 17 further obtains reception state information of the shared digital center 10c to confirm a current reception state at the shared digital center 10c (step B30). If the shared digital center 10c is in a good reception state (the “good reception” route in step B30), the shared digital center 10c distributes the broadcast distribution signal to the downstream local stations 14 and concurrently sends the signal to the shared digital center 10a through the backup line 15 (step B80). Then the procedural steps proceed to step B110.

If the shared digital center 10c also has poor reception (the “poor reception” route in step B30), the signal replacement section 17 confirms a reception state at each of the remaining shared digital centers 10 in the digital broadcast signal distribution system 1 (step B40). If all the remaining shared digital centers 10 are in a poor reception state (Yes route in step B40), each shared digital center 10 in the digital broadcast signal distribution system 1 carries out layered transmission for the broadcast distribution signal (step B90) and completes the procedural steps. On the other hand, if at least one of the remaining shared digital centers 10 has good reception (No route in step B40), the broadcast distribution signal received at the one shared digital center 10 that has good reception is sent to one or more shared digital centers 10 that issue a signal distribution request (step B100) and the procedural steps are completed. Since the example of the digital broadcast signal distribution system 1 shown in FIG. 2 has three shared digital centers 10a, 10b and 10c, the steps B40, and B100 are not performed and the procedural steps move from the poor reception route in step B30 to step B90.

A first transmitting cable 16 and a second transmitting cable 13 are used to transmit broadcast distribution signals distributed from a shared digital center 10, and are formed by coaxial cables, optical fiber cables, HFCs (Hybrid Fiber/Coax Cables) or the like. In the illustrated example, first transmitting cables 16 are formed by optical fiber cables and second transmitting cables 13 are formed by HFCs. These first transmitting cables 16 and second transmitting cables 13 should by no means be limited to the above example; alternatively, a first transmitting cable 16 and a second transmitting cable 13 may be respectively formed by a HFC and an optical fiber, respectively. Types of first transmitting cable 16 and a second transmitting cable 13 can be changed without departing from the concept of the present invention.

In the digital broadcast signal distribution system 1, digital transmission is performed on broadcast distribution signals (digital signals) that each shared digital center 10 distributes to downstream local stations 14 and downstream subscriber homes 12 or each local station 14 distributes to downstream subscriber homes 12.

A local station 14 distributes a broadcast distribution signal received from the upstream shared digital center 10 to downstream subscriber homes 12. A local station 14 functions as a head end (an originating point) to receive a broadcast distribution signal, which the upstream shared digital center 10 distributes, through a first transmitting cable 16 and distributes the received signal to subscriber homes 12 in the area of the shared digital center 10 itself through second transmitting cables 13. Additionally, a local station 14 also serves as a repeater to relay digital broadcast signals in the digital broadcast signal distribution system 1.

When a shared digital center 10 or a local station 14 functions as a head end in the digital broadcast signal distribution system 1, a broadcast distribution signal distributed from the head end has information (HE identification No.), added to the header of, for example, the transport stream (TS) of the broadcast distribution signal, to specify the head end.

A shared digital center 10 of the first embodiment is connected to a number of local stations 14. Local stations 14a-1, 14a-2 and 14a-3 are connected to the upstream shared digital center 1a; local stations 14b-1, 14b-2 and 14b-3, to the upstream shared digital center 10b; and local stations 14c-1, 14c-2 and 14c-3, to the upstream shared digital center 10c.

A local station 14c-4 is further connected to the local station 14c-3 through a first transmitting cable 16 so that the local station 14c-3 relays (distributes) a broadcast distribution signal received from the upstream shared digital center 10c to the local station 14c-4.

Hereinafter, reference numbers 14a-1 to 14a-3, 14b-1 to 14b-3 and 14c-1 to 14c-4 are used when particular local stations have to be specified while an arbitrary local station is represented by reference number 14.

A number of subscriber homes 12 are connected to each of local stations 14 through second transmitting cables 13. Subscriber homes 12a-2 are connected to the local station 14a-2; subscriber homes 12b-2, to the upstream local station 14b-2; and subscriber homes 12c-4, to the upstream local station 14c-4.

Hereinafter, a particular subscriber home is represented by reference number 12a-2, 12b-2, or 12c-4 while an arbitrary subscriber home is represented by reference number 12. FIG. 2 omits subscriber homes 12 connected to local stations 14a-1, 14a-3, 14b-1, 14b-3, 14c-1, 14c-2 and 14c-3, for convenience.

A local station 14 distributes, to the subscriber homes 12 in the area of the local station 14 in question, a broadcast distribution signal that is a combination of a broadcast distribution signal received from the upstream shared digital center 10 and a broadcast distribution signal of local programs peculiar to the local station 14 in question. Each local station 14 distributes a broadcast distribution signal to downstream subscriber homes 12 based on channel distribution plans peculiar to the local station 14 in question. In the digital broadcast signal distribution system 1 of the first embodiment, each local station 14 puts a signal of a local program into a vacant transmission band interposed between transmission bands occupied by a broadcast distribution signal from the upstream shared digital center 10. Thereby the local station 14 creates a peculiar broadcast distribution signal by adding a broadcast distribution signal representing local programs to a broadcast distribution signal received from the upstream shared digital center 10 and/or replacing a part of the broadcast distribution signal from the upstream shared digital center 10, which part represents a particular program, with a signal representing a local program, and distributes the peculiar broadcast distribution signal to the subscriber homes 12 in the area of the local station 14 (the downstream subscriber homes 12).

Further, if the local station 14 distributes a broadcast distribution signal, received from a shared digital center 10 other than the upstream shared digital center 10, to subscriber homes 12, the local station 14 does not change at least PSI/SI (Program Specific Information/Service Information) of the broadcast distribution signal.

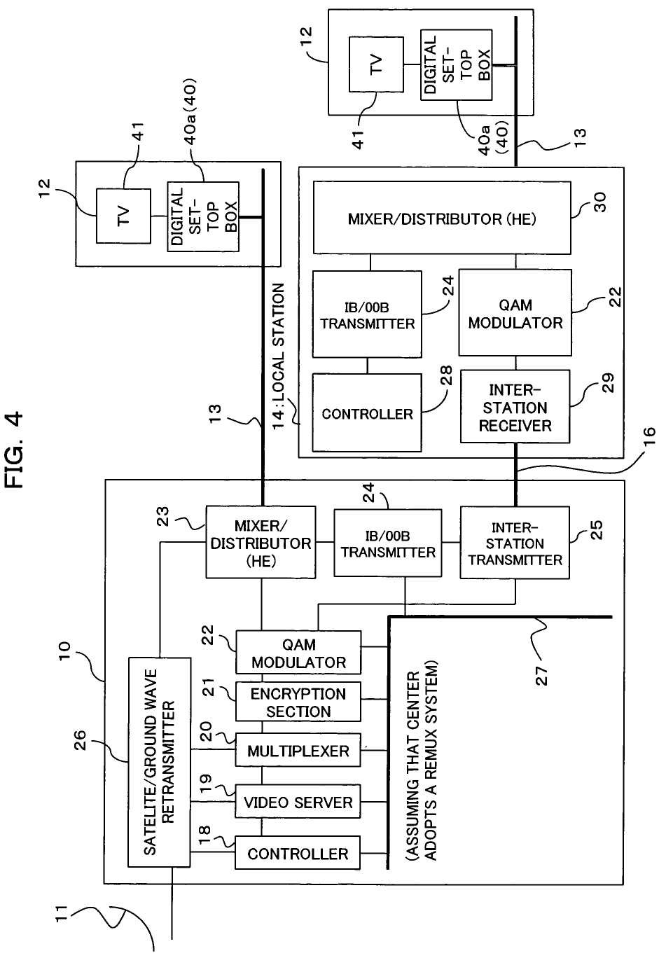

FIG. 4 is a block diagram schematically showing the digital broadcast signal distribution system 1. The system in FIG. 4 is simplified to include a shared digital center 10, a local station 14 and two subscriber homes 12 for convenience. Reference numbers in the accompanying drawing represent parts or elements identical or substantially identical to those having the same reference numbers already described, so repetitious description is omitted here. Further, the shared digital center (distribution center) 10 in FIG. 4 distributes a broadcast distribution signal to the local station 14 through a first transmitting cable 16 and also to a subscriber home 12 through a second transmitting cable 13.

As shown in FIG. 4, a shared digital center 10 comprises a controller 18, a video server 19, a multiplexer 20, an encryption section 21, a QAM modulator 22, a HE mixer/distributor 23, an IB/OOB (in-band/out-of-band) transmitter 24, an inter-station transmitter 25, a satellite/wave retransmitter 26, and a bus 27 for the entire management. The controller 18 controls the other parts and elements in the shared digital center 10 through the bus 27. The video server 19 accumulates video contents such as motion image and controls distribution of the contents to subscribers.

The multiplexer 20 multiplexes various data such as distribution video information and bi-directional communication data. The encryption section 21 encrypts data multiplexed in the multiplexer 20 by scrambling the data. The QAM modulator 22 modulates a signal into a suitable form for transmission through a CATV network (a first transmitting cable 16). The mixer/distributor 23 is generally called a head end (HE) and sends out a signal modulated in the QAM modulator 22 to downstream subscriber homes 12 through first transmitting cables 16.

The IB/OOB transmitter 24 sends out various data such as channel distribution plans (to be described later) together with a broadcast distribution signal by either In-Band (IB) data transmission method or Out-Of-Band (OOB) data transmission method, which methods will be described later.

An inter-station transmitter 25 distributes a signal modulated in the QAM modulator 22 to downstream local stations 14. The satellite/wave retransmitter 26 executes distribute service of digital image and voice data.

Although omitted in FIG. 4, a shared digital center 10 may have a function as a router, a cable modem, and/or a data communication device so as to provide subscriber homes 12 with communication service, in addition to distribution of video and audio data, in order to connect PCs (Personal Computers) in the subscriber homes 12 to the Internet.

A local station 14 (a CATV local station) includes, as shown in FIG. 4, a controller 28, an IB/OOB (in-band/out-of-band) transmitter 24, a mixer/distributor 30, an inter-station receiver 29 and a QAM modulator 22.

The controller 28 controls each section in the local station 14 for overall management. The inter-station receiver 29 receives a broadcast distribution signal sent out from the upstream shared digital center 10. The QAM modulator 22 can be replaced with a frequency converter, and can be changed or/and modified as long such changes and modifications are as within the scope of the present invention.

Each subscriber home 12 includes a digital set-top box 40a and a television (TV) 41. A broadcast distribution signal sent from a local station 14 or a shared digital center 10 is received in a digital set-top box 40a, which obtains video data and audio data and provides the TV 41 with the obtained data. Hereinafter, a digital set-top box 40a is sometimes simply called a STB 40a.

A STB 40a is a subscriber terminal to receive digital broadcast distribution signals distributed from the upstream shared digital center 10 or from another shared digital center 10 via the upstream shared digital centers 10 through first transmitting cables 16 and second transmitting cables 13 so that a subscriber may view a program. A STB 40a includes a distribution plan storage 401, a distribution center discrimination section 402 and a receiving section 403 as shown in FIG. 1.

The distribution plan storage 401 retains channel distribution plans, one representing distribution setting information of a broadcast distribution signal created in each shared digital center 10. The distribution center discrimination section 402 discriminates a shared digital center 10 that has created the broadcast distribution signal received in the STB 40a in question. The receiving section 403 receives the broadcast distribution signal by changing, if the broadcast distribution signal is distributed from a shared digital center 10 other than a predetermined (upstream) shared digital center 10, an NIT (a Network Information Table) of the digital broadcast distribution signal received therein based on the channel distribution plans of the discriminated shared digital center 10 and the predetermined shared digital center 10.

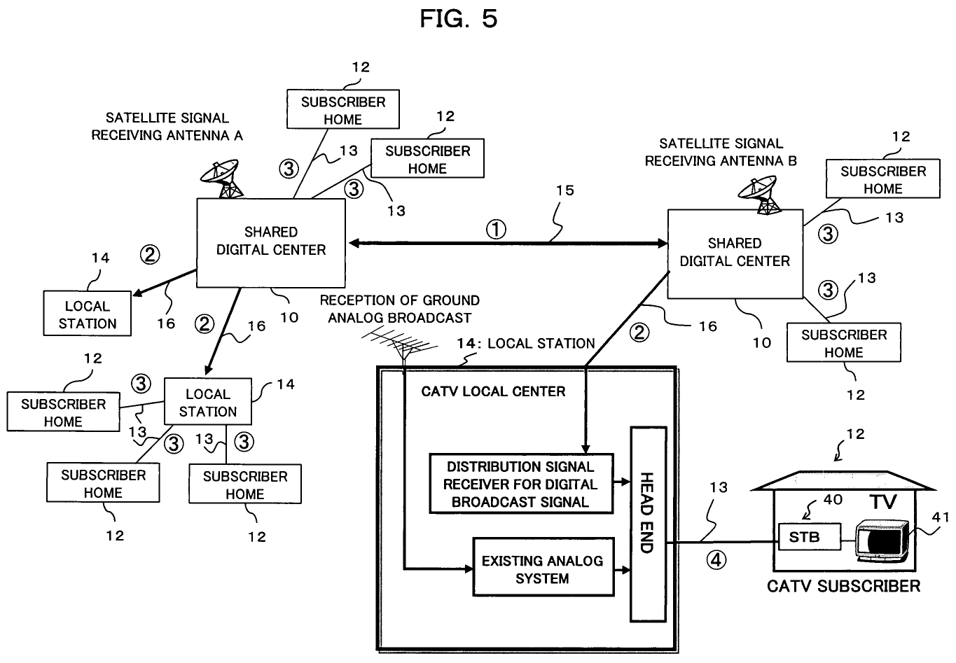

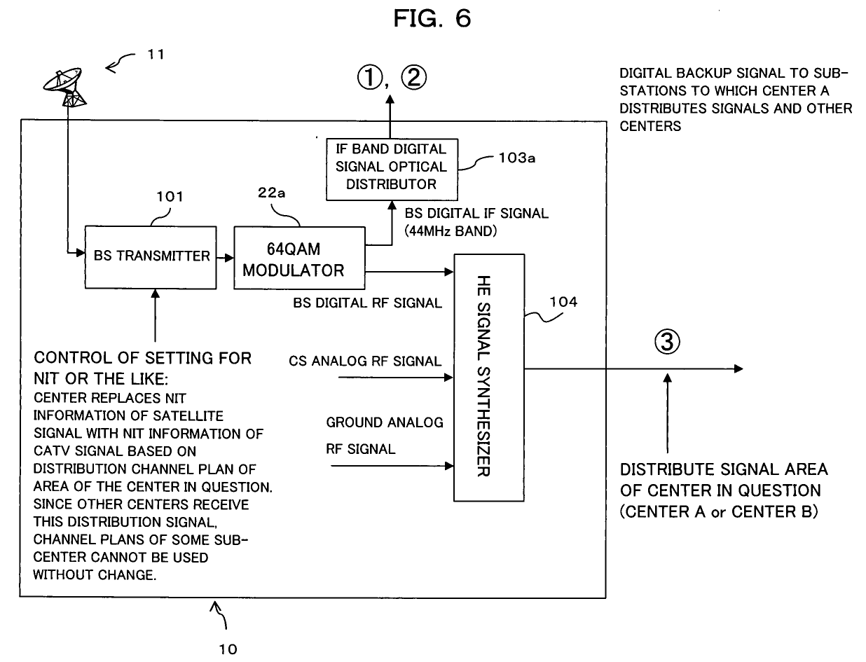

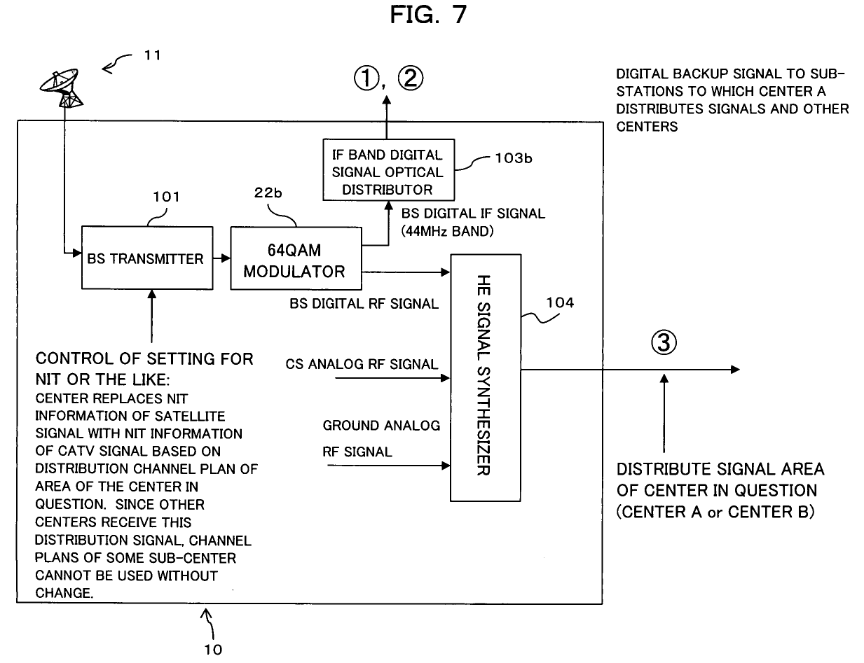

FIG. 5 shows a relationship between a shared digital center 10 and a local station 14 in the digital broadcast signal distribution system 1. FIGS. 6 and 7 schematically show configurations of a shared digital center 10 in the digital broadcast signal distribution system 1. FIG. 6 is an example of a shared digital center 10 which distributes a broadcast distribution at radio frequency (RF) to another shared digital center 10 and/or a local station 14; FIG. 7 is an example of a shared digital center 10 which distributes a broadcast distribution at intermediate frequency (IF) to another shared digital center 10 and/or a local station 14.

As shown in FIG. 5, a shared digital center 10 distributes a broadcast distribution signal to downstream local stations 14 through first transmitting cables 16 and concurrently to downstream subscriber homes 12 through second transmitting cables 13, and further sends the broadcast distribution signal to another shared digital center 10 through the backup line 15.

In FIGS. 5-7, an encircled reference number 1 (\mathring{1}) represents a signal that a shared digital center 10 sends to another shared digital center 10 through backup line 15; an encircled reference number 2 (\mathring{2}) represents a signal that a shared digital center 10 is distributing to a downstream local station 14 through first transmitting cable 16; and an encircled reference number 3 (\mathring{3}) represents a signal that a shared digital center 10 is distribution to a downstream subscriber home 12 through a second transmitting cable 13, for convenience.

A shared digital center 10 includes, as shown in FIG. 6, a receiving antenna 11, a BS transmitter 101, a 64 QAM modulator 102a, an RF band digital signal optical distributor 103a and a HE signal synthesizer 104.

A BS transmitter 101 divides and converts a BS digital broadcast signal that has been received at a receiving antenna 11 to signals in a CATV transmission format, and corresponds to the above-mentioned controller 18, video server 19, multiplexer 20, encryption section 21, satellite/wave retransmitter 26 and the like. The BS transmitter 101 replaces NIT information for a satellite signal with NIT information for CATV in accordance with a distribution channel plan of the area of the shared digital center 10 in question. When another shared digital center 10 and a downstream local station 14 of the other shared digital center 10 receive a broadcast distribution signal, NIT information of which was replaced by the BS transmitter 101 in the shared digital center 10 in question, the received shared digital center 10 and the local station 14 thereof cannot utilize the NIT information without changing it.

A 64 QAM modulator 22a modulates a signal into a suitable form for sending out to a CATV network (a first transmitting cable 16), more specifically, modulates a broadcast distribution signal to a BS digital RF signal at radio frequency and inputs the modulated BS digital RF signal into an RF band digital signal optical distributor 103a and the HE signal synthesizer 104.

An RF band digital signal optical distributor 103a distributes BS digital RF signals \mathring{1} and \mathring{2} to another shared digital center 10 through the backup line 15 and/or to a downstream local station 14 thereof through a first transmitting cable 16. An HE signal synthesizer 104 mixes a BS digital RF signal modulated in the RF band digital signal optical distributor 103a with a CS analog FR signal and/or an analog RF signal to synthesize a broadcast distribution signal \mathring{3} and distributes the synthesized signal to a downstream subscriber home 12 through a second transmitting cable 13. Namely, an HE signal synthesizer 104 corresponds to the above-described HE mixer/distributor 23.

The configuration of a shared digital center 10 should by no means be limited to that of FIG. 6; an alternative shared digital center 10 may distribute an IF digital broadcast distribution signal at intermediate frequency (IF) to another shared digital center 10 and/or a downstream local station 14 thereof, as shown in FIG. 7. A shared digital center 10 of FIG. 7 includes an IF band digital signal optical distributor 103b and 64 QAM modulator 22b, as substitutions for an RF band digital signal optical distributor 103a and a 64 QAM modulator 22a in FIG. 6, respectively.

A 64 QAM modulator 22b modulates a broadcast distribution signal that has been received in the BS transmitter 101 to a BS digital RF signal at radio frequency and sends the modulated BS digital RF signal into the HE signal synthesizer 104 and concurrently modulates the broadcast distribution signal into a BS digital IF signal at intermediate frequency (e.g., 44 MHz) and sends the modulated IF signal into the IF band digital signal optical distributor 103b.

The IF band digital signal optical distributor 103b distributes BS digital IF signals \mathring{1} and \mathring{2} to another shared digital center 10 through the backup line 15 and/or to a downstream local station 14 through a first transmitting cable 16.

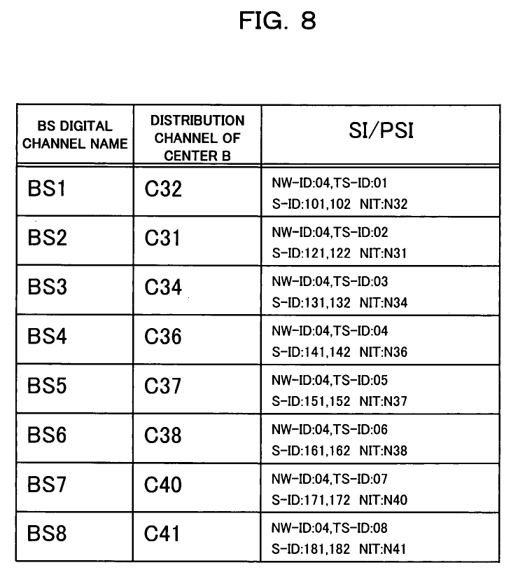

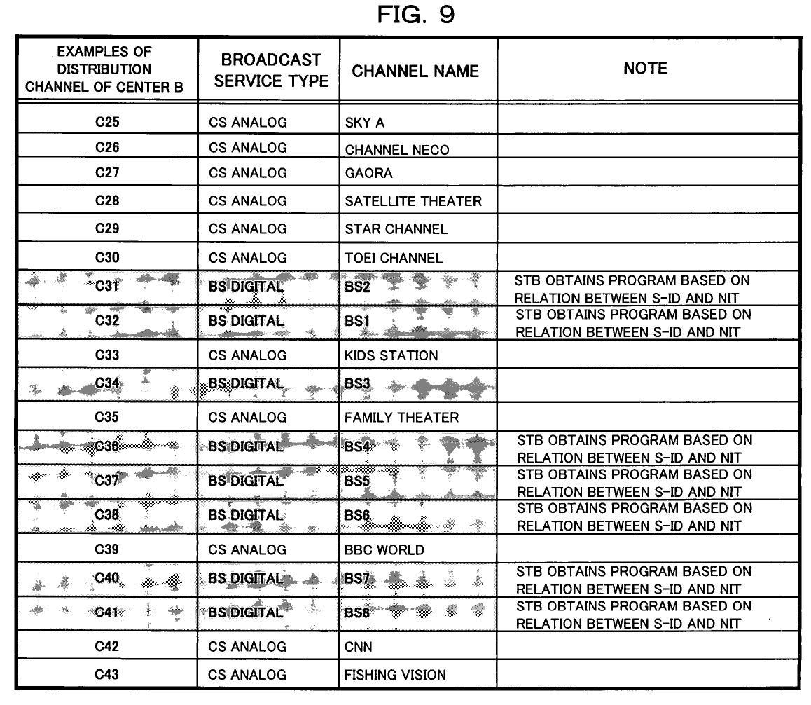

FIG. 8 shows an example of distribution channels of BS digital broadcast distribution signals at a particular shared digital center 10 in the digital broadcast signal distribution system 1. The table of FIG. 8 associates the name of a BS broadcast channel with a distribution channel and PSI/SI. Table FIG. 9 shows an example of a part of a channel distribution plan of the same shared digital center and associates a distribution channel with a broadcast service type, a channel name, and a note.

As shown in FIGS. 8 and 9, the shared digital center 10 in question distributes BS digital broadcast programs to downstream subscriber terminals 12 using channels C31, C32, C34, C36-C38, C40 and C41.

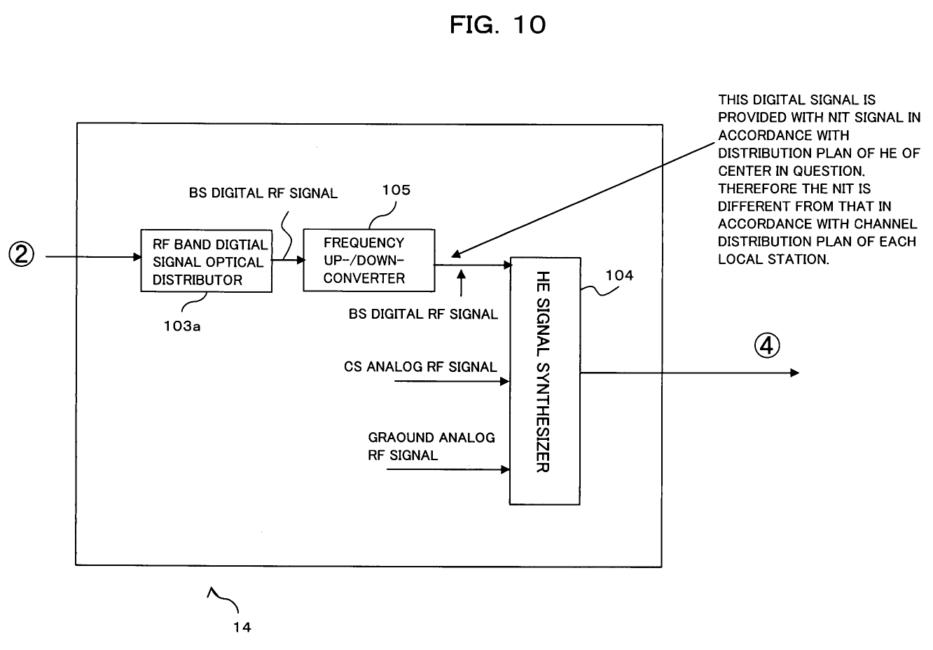

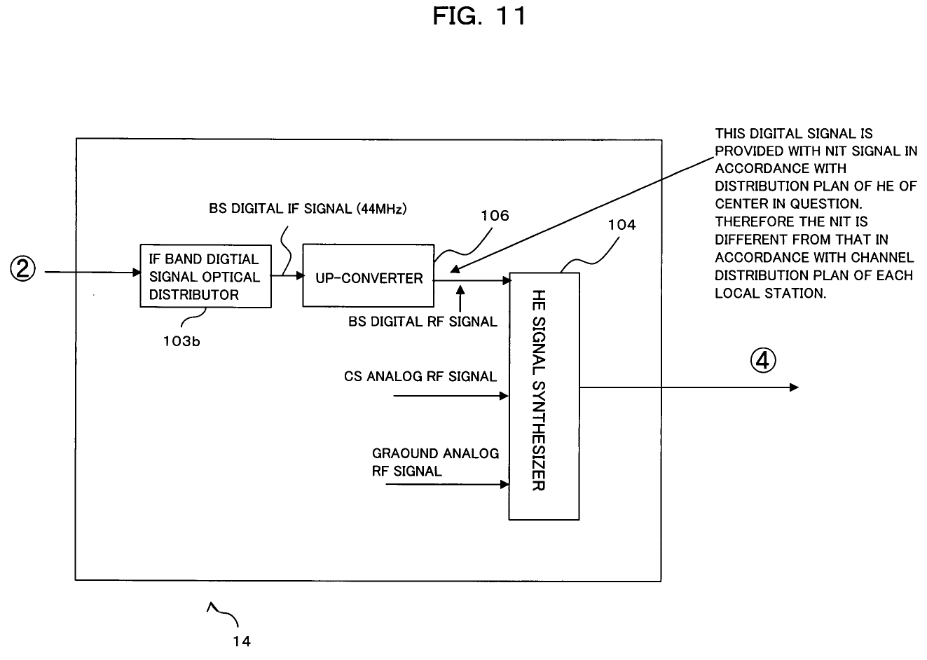

FIGS. 10 and 11 respectively show manners in which broadcast distribution signals is distributed to a subscriber home 12 from a local station 14 of the digital broadcast signal distribution system 1. FIG. 10 schematically shows the functional configuration of a local station 14 that receives an RF (Radio Frequency) digital signal as a broadcast distribution signal and distributes the signal to downstream subscriber homes 12; and FIG. 11 shows a distribution manner of a local station 14 that receives an IF (Intermediate Frequency) digital signal as a broadcast distribution signal and then distributes the signal to downstream subscriber homes 12.

As shown in FIG. 5, a local station 14 distributes a broadcast distribution signal to a downstream subscriber home 12 through a second transmitting cable 13. A signal with an encircled reference number 4 (\mathring{4}) in FIGS. 5, 10 and 11 represents a signal that a local station 14 distributes a subscriber home 12 through a second transmitting cable 13.

A local station 14, as shown in FIG. 10, includes a RF band digital signal optical distributor 103a, a frequency up-/down-converter 105 and a HE signal synthesizer 104. Reference numbers in the accompanying drawing represent parts or elements identical or substantially identical to those with the same reference numbers already described, so repetitious description is omitted here.

A frequency up-/down-converter 105 adjusts the frequency of a BS digital RF signal \mathring{2} (a broadcast distribution signal) that has been received in an RF band digital signal optical distributor 103a from the upstream shared digital center 10 to a frequency that can be mixed with another analog signal in the HE signal synthesizer 104 and that can be distributed to a subscriber home 12. NIT information in line with a channel distribution plan of the shared digital center 10, the distribution source, is added to a BS digital RF signal to be sent out from the frequency up-/down-converter 105. In other words, the channel distribution plan of the local station 14 in question is different from that of another local station 14 that receives the broadcast distribution signal from another shared digital center 10.

After that, the HE signal synthesizer 104 mixes the BS digital RF signal with a CF analog RF signal and/or an analog RF signal to synthesize a broadcast distribution signal \mathring{3} and distributes the synthesized signal \mathring{3} to a subscriber home 12 through a second transmitting cable 13.

The configuration of a local station 14 should by no means be limited to that in FIG. 10; an alternative local station 14 may receive a broadcast distribution signal in the form of a digital signal at IF (Intermediate Frequency) and distributes the received digital IF signal to a subscriber home 12, as shown in FIG. 11. A local station 14 in FIG. 11 includes an IF band digital signal optical distributor 103b and a frequency up-converter 106, which are substitutes for an RF band digital signal optical distributor 103a and a frequency up-/down-converter 105 of a local station 14 shown in FIG. 10.

A frequency up-converter 106 adjusts (down converts) the frequency of a BS digital IF signal (a broadcast distribution signal) \mathring{2} received in the IF band digital signal optical distributor 103b from the upstream shared digital center 10 such that the down-converted signal can be mixed with another analog signal in an HE signal synthesizer 104 and be distributed to downstream subscriber homes 12. NIT information in line with the upstream shared digital center 10, the distribution source, is also added to the BS digital RF signal that is to be output from the frequency up-converter 106. In other words, the channel distribution plan of the local station 14 in question is different from that of a local station 14 that receives the broadcast distribution signal from another shared digital center 10.

After that, the HE signal synthesizer 104 mixes the BS digital RF signal with a CS analog RF signal and/or an analog RF signal to synthesize a broadcast distribution signal \mathring{4} and distributes the broadcast distribution signal \mathring{4} to a subscriber home 12 through a second transmitting cable 13.

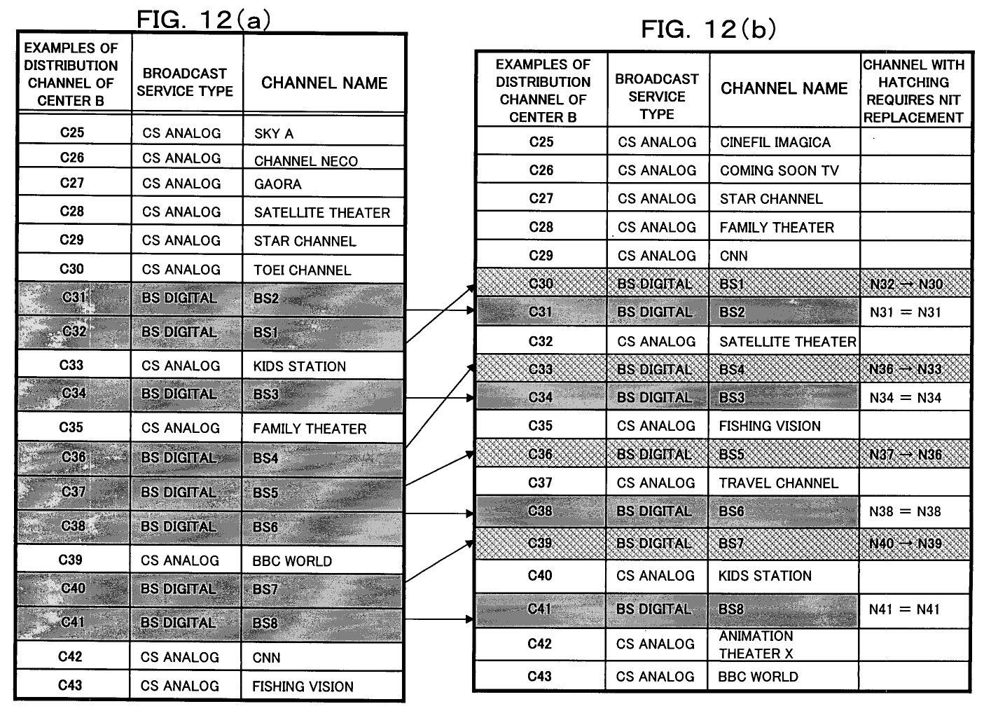

FIGS. 12(a) and 12(b) respectively show channel distribution plans of a shared digital center 10 and a subscriber home 12 for comparison. A local station 14 having a channel distribution plan of FIG. 12(b) distributes a broadcast distribution signal, received from a shared digital center 10 having a channel distribution plan of FIG. 12(a), to a subscriber home 12 in accordance with the channel distribution plan retained in the local station 14 in question.

As shown in FIGS. 12(a) and 12(b), a local station 14 changes a part of the NIT of a broadcast distribution signal received from the upstream shared digital center 10 so that the broadcast distribution signal can be distributed to subscriber home 12 in line with the channel distribution plan of the local station 14 in question.

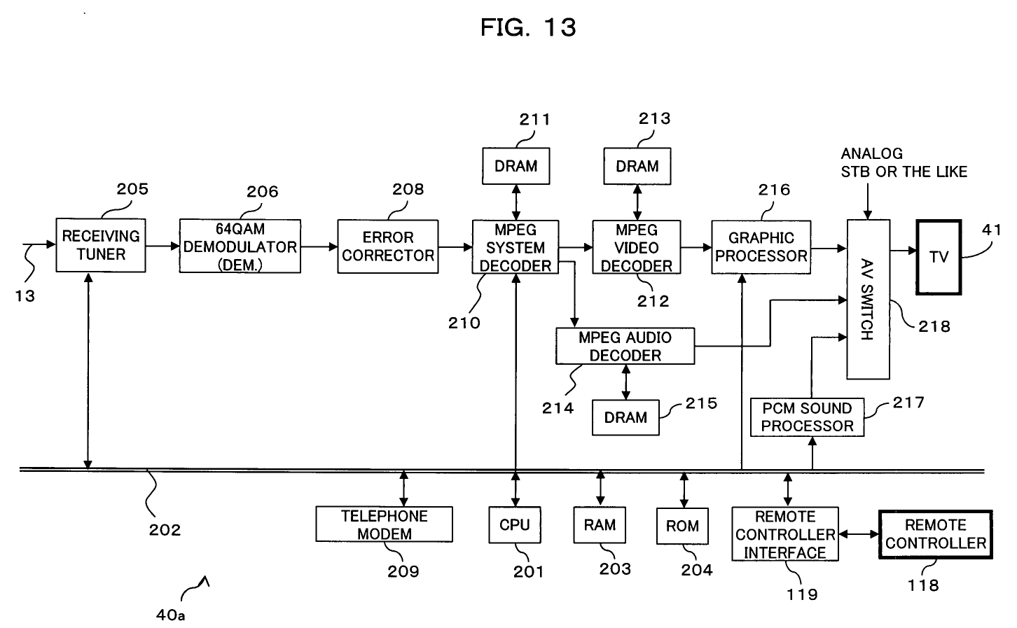

FIG. 13 schematically shows a STB (a subscriber terminal) 40a included in the digital broadcast signal distribution system 1 of the first embodiment. The STB 40a in FIG. 13 is a uni-directional digital set-top box that receives only a downstream RF signal sent out from the upstream local station 14 or from the upstream shared digital center 10.

The STB 40a, as shown in FIG. 13, includes a receiving tuner (a receiving section) 205, a 64 QAM demodulator (DEM.) 206, an error corrector 208, a telephone modem 209, an MPEG system decoder 210, DRAMs 211, 213 and 215, an MPEG video decoder 212, an MPEG audio decoder 214, a graphics processor 216, a PCM sound processor 217, an AV switch 218, a CPU (Central Processing Unit: a distribution center discrimination section) 201, a bus 202, a RAM (Random Access Memory: a distribution plan storage) 203, a ROM (Read Only Memory) 24, a remote controller interface 119 and a remote controller 118.

The lower part of the bus 202 in a STB 40a of FIG. 13 forms a computer system including the CPU 201 at the center, the RAM 203 and the ROM 204 while the upper part of the bus 202 forms a program data reproduction system.

The receiving tuner 205 receives a transmission signal (a broadcast distribution signal) through a second transmitting cable 13 and supplies the 64 QAM demodulator 206 with the received signal. Further, the receiving tuner 205 selectively receives a program that a subscriber (an operator) designates using the remote controller 118. In the first embodiment, the receiving tuner 205 functions as the distribution center discrimination section 402 and the receiving section 403 described above.

The receiving tuner 205 can tune to physical channels defined within, for example, 90 to 770 MHz. The receiving tuner 205 receives a transmission signal at a predetermined frequency through a second transmitting cable 13 and supplies the 64 QAM demodulator 206 with the received transmission signal. A process performed by the receiving tuner 205 will be described later.

The 64 QAM demodulator 206 demodulates the received transmission signal and the error corrector 208 corrects an error in the transmission signal demodulated by the 64 QAM demodulator 206.

The MPEG system decoder 210 decodes the transmission signal, an error of which has been corrected in the error corrector 208, to divide video data from audio data in the signal. The MPEG video decoder 212 decodes the video data and the MPEG audio decoder 214 decodes the audio data.

The MPEG system decoder 210, the MPEG video decoder 212, and the MPEG audio decoder 214 respectively have DRAMs 211, 213, and 215 serving as buffers for data processing.

The telephone modem 209 communicably connects the STB 40a to the upstream local station 14 through a public telephone line (not shown). Thereby the STB 40a establishes a connection with the upstream local station 14 through the telephone modem 209 and a public telephone line as required to send and receive various information pieces such as a channel distribution plan with the upstream local station 14.

The graphics processor 216 creates, on the basis of the transmission signal decoded in the MPEG video decoder 212, video information of letters and images that are to be displayed in response to instructions from the CPU 201 and superimposes the created video information on video information from an MPEG video decoder. The AV switch 218 receives video information from the graphics processor 216 and audio data from the MPEG audio decoder 214, voice information from the PCM sound processor 217 and video and voice information from an external analog set-top box. The AV switch 218 switches particular video information and particular voice information among received information and provides the television receiver (TV) 41 with the switched information.

Digital data input through the bus 202 is processed in the PCM sound processor 217 and then output from the AV switch 218. With these functional sections in a shared digital center 10, a local station 14 and a CATV subscriber home 12, it is possible to provide a VOD (Video On Demand) service that provides a subscriber with a desired program whenever the subscriber wishes, and additionally a TV shopping service that allows a subscriber to retrieve commodity information at home so that the subscriber can purchase a desired commodity, and a bi-directional communication service (interactive service) such as that for distribution of game data and karaoke data.

The CPU 201 controls entire operations performed in the STB 40a, and is connected to the receiving tuner 205, the MPEG system decoder 210, the PCM sound processor 217, the remote controller interface 119, the RAM 203 and the ROM 204 through the bus 202. Execution of programs and data stored in the RAM 203 and the ROM 204 by the CPU 201 causes the above parts and elements to function. Further, execution of the programs and the data by the CPU 201 cause the CPU 201 itself to function as a distribution center discrimination section to discriminate a shared digital center 10 (a local station 14) that has created a digital broadcast distribution signal received in the STB 40a in question.

With this configuration of a STB 40a, when a subscriber inputs information (e.g., service ID or service switch code (service switch information for CS digital or BS digital broadcast)) to designate a view-desired program using a remote controller 118, the STB 40a selectively receives the designated program from a broadcast distribution signal being received in the receiving tuner 205 and displays the program on the TV 41 whereupon the subscriber views the desired program.

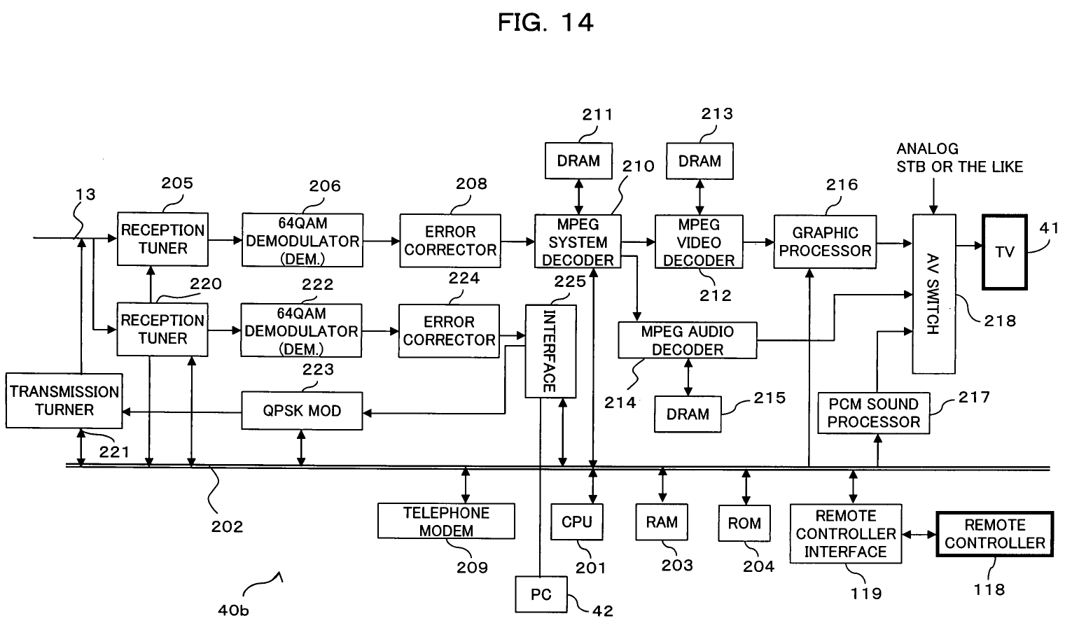

FIG. 14 shows another example of a STB (a subscriber terminal) included in the digital broadcast signal distribution system 1 of the first embodiment. The digital broadcast signal distribution system 1 may include a STB 40b shown in FIG. 14 as a substitute for a STB 40a shown in FIG. 13.

A STB 40b had an additional function as a cable modem to functions included in a STB 40a shown in FIG. 13. A STB 40b is connected to a PC (Personal Computer) 42 so that the PC 42 is connected to the Internet through a second transmitting cable 13 and the upstream shared digital center 10. Namely, a STB 40b serves as a bi-directional digital set-top box that can receive a downstream RF signal from the upstream shared digital center 10 or the upstream local station 14 and can send an upstream RF signal to a non-illustrated file server.

Specifically, a STB 40b, as shown in FIG. 14, includes a receiving tuner 220, a transmitting tuner 221, a 64 QAM modulator 22b, a QPSK modulator (MOD.) 223, an error corrector 224 and an interface 225 in addition to the elements included in a STB 40a shown in FIG. 13. Reference numbers in the accompanying drawing represent parts or elements identical or substantially identical to those with the same reference numbers already described, so repetitious description is omitted here.

The receiving tuner 220 receives communication data from the second transmitting cable 13 and inputs the received communication data into the 64 QAM demodulator 222. The 64 QAM demodulator 222 demodulates communication data received from the receiving tuner 220 and the error corrector 224 corrects an error in the communication data modulated in the 64 QAM demodulator 222. The interface 225 is connected to the PC 42 and receives and sends communication data or the like with the PC 42.

The QPSK modulator 223 sends communication data and modulates communication data to be sent out from the PC 42, using QPSK (Quadrature Phase Shift Keying) technique. The transmitting tuner 221 sends the communication data modulated in the QPSK modulator 223 to the second transmitting cable 13.

Additionally, using a STB 40b as a cable modem or preparing another cable modem allows a PC 42 installed in a subscriber home to receive Internet connection service in a high-speed accessible environment through a second transmitting cable 13.

An interactive service utilizing such a CATV system realizes video on demand, karaoke data distribution, game data distribution, TV shopping, PC communication, the Internet, telephone, TV telephone/conference, downloading sales of software or/and distance learning.

When a function as a cable modem is utilized, a CATV can provide an Internet connection service in a high-speed accessible environment differently from the service provided through a telephone network so that subscribers can receive various interactive services. A physical channel for high-speed data communication for such interactive service is different in cable transmission bandwidth from a CATV physical channel for program distribution so that interactive service and program distribution can be concurrently realized.

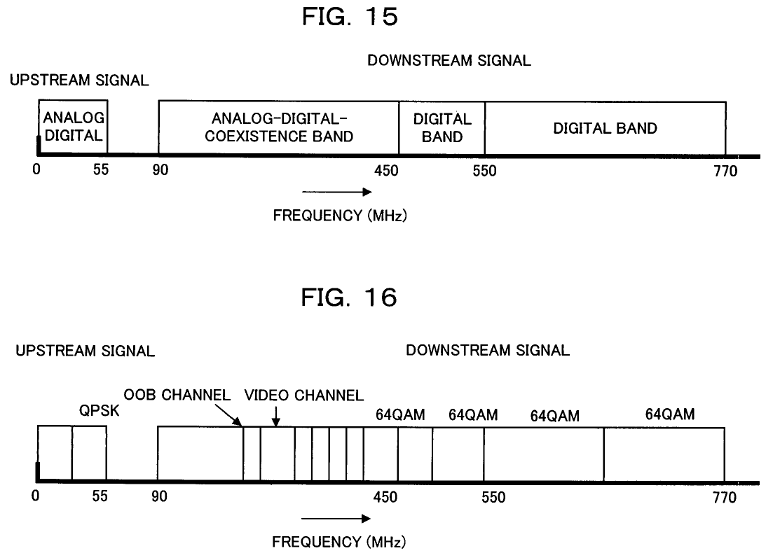

FIGS. 15 and 16 respectively show examples of frequency division in line with each CATV channel service. FIG. 15 is an example to send analog signals and digital signals in different frequency bandwidths and FIG. 16 is an example to send broadcast distribution signals and data communication signals into different frequency bandwidths. Subscribers can receive both program distribution service and data communication service using either of these frequency divisions.

In the digital broadcast signal distribution system 1, data communication is performed by either InBand data transmission (IB) or Out-Of-Band data transmission (OOB).

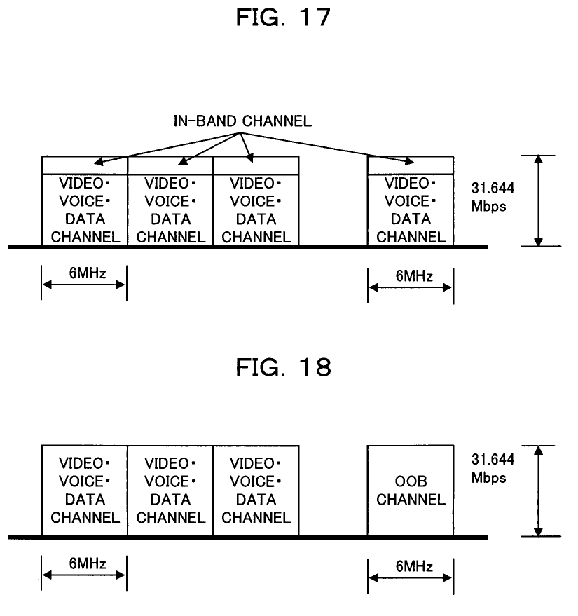

FIG. 17 shows an In-Band data transmission method and FIG. 18 shows an Out-Of-Band data transmission method. In-Band data transmission inserts data signals into a bandwidth for transmitting a main signal to transmit the data signals, as shown in FIG. 17, and particularly in a CATV, inserts data signals into an NTSC or QAM channel. Especially for CATV, in-band data transmission is the most appropriate to transmit data, such as captions and recipes, associated with program contents.

As shown in FIG. 18, Out-Of-Band data transmission transmits data signals using a bandwidth other than those for transmitting main signals. A STB 40 includes a tuner dedicated to OOB data transmission separately from the main tuner so that the STB 40 can always receive OOB data irrespective of channel selection. OOB data transmission is particularly suitable for signals, associated with all the service bands, such as STB controlling, network monitoring, EPG and emergency broadcasting.

In the first embodiment, various data (e.g., HE discrimination information, a channel distribution plan, or a control signal) can be sent and received between the STB 40a and a shared digital center 10 or a local station 14 using such data transmission methods.

Hereinafter, a particular STB is identified by a reference number 40a or 40b while an arbitrary STB is represented by reference number 40.

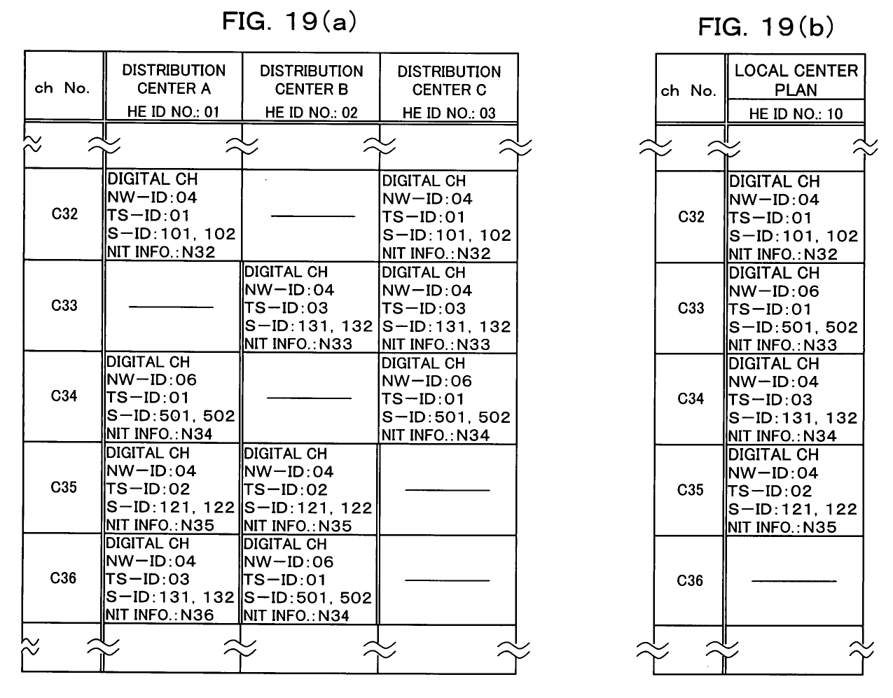

A STB (a subscriber terminal) 40 in the digital broadcast signal distribution system 1 retains a channel map table shown in FIGS. 19(a) and 19(b) in a rewritable form in the RAM 203 or ROM 204 therein. Namely, the RAM 203 functions as the foregoing distribution plan storage 401 in the first embodiment.

FIGS. 19(a) and 19(b) show examples of a channel map table representing channel distribution plans in the first embodiment. FIG. 19(a) shows an example of channel distribution plans of other distribution centers and FIG. 19(b) shows an example of the channel distribution plans of the distribution center in question.

A channel map table stores distribution setting information (a channel distribution plan) of each channel in a broadcast distribution signal to be distributed from each head end (a shared digital center 10 or a local station 14). Specifically, a channel map table is, as shown in FIG. 19(a), a list in which a channel number (ch No.) of a broadcast distribution signal to be distributed from each shared digital center 10 is correlated with information (NW-ID, TS-ID, S-ID and NIT information; hereinafter sometimes collectively called a channel distribution plan piece) associated with a program distributed on the channel. Namely, such a channel map table exhibits a program list broadcast in each shared digital center 10 (or local station 14) and a correlation between each CATV channel and a program broadcast on the CATV channel.

Information NW-ID specifies a service type and is included in a digital signal distributed from a BS or CS satellite. Information TS-ID specifies a transport stream and information S-ID (service-ID) specifies a program.

The example channel map table shown in FIG. 19(a) represents channel distribution plans of head ends (shared digital centers 10) respectively having HE ID numbers 01, 02 and 03, and are stored in STBs 40 downstream of the above head ends.

For example, a distribution center A (a shared digital center 10a) distributes a program having NW-ID=04, TS-ID=01, S-ID=101, 102 and NIT information=N32 on channel C32; a program having NW-ID=06, TS-ID=01, S-ID=501, 502 and NIT information=N34 on channel C34; a program having NW-ID=04, TS-ID=02, S-ID=121, 122 and NIT information=N35 on channel C35; and a program having NW-ID=04, TS-ID=03, S-ID=131, 132 and NIT information=N36 on channel C36.

Fields with horizontal bars in FIGS. 19(a) and 19(b) indicate channels that include no digital distribution information (NIT information), i.e., void channels, on which no program is distributed. Therefore, the distribution center A does not distribute a program on channel C33.

A distribution center B (a shared digital center 10b) distributes a program having NW-ID=04, TS-ID=03, S-ID=131, 132 and NIT information=N33 on channel C33; a program having NW-ID=04, TS-ID=02, S-ID=121, 122 and NIT information=N35 on channel C35; and a program having NW-ID=06, TS-ID=01, S-ID=501, 502 and NIT information=N34 on channel C36. Channels C32 and C34 are void channels.

A distribution center C (a shared digital center 10c) distributes a program having NW-ID=04, TS-ID=01, S-ID=101, 102 and NIT information=N32 on channel C32; a program having NW-ID=04, TS-ID=03, S-ID=131, 132 and NIT information=N33 on channel C33; and a program having NW-ID=06, TS-ID=01, S-ID=501, 502 and NIT information=N34 on channel C34.

As shown in FIG. 19(b), each STB 40 also stores, in the channel map table, a channel distribution plan of the upstream shared digital center 10 (i.e., the local center) that directly distributes a broadcast distribution signal to the STB 40.

The example channel map table of FIG. 19(b) is stored in the STBs 40 installed in the subscriber homes 12 down stream of the head end (a shared digital center 10) having an HE ID number 10.

The upstream distribution center (shared digital center 10) of the STBs 40, as shown in FIG. 19(b), distributes a program having NW-ID=04, TS-ID=01, S-ID=101, 102 and NIT information=N32 on channel C32; a program having NW-ID=06, TS-ID=01, S-ID=501, 502 and NIT information=N33 on channel C33; and a program having NW-ID=04, TS-ID=03, S-ID=130, 131 and NIT information=N33 on channel C34.

If the upstream distribution center with ID number 10 has poor reception, the upstream distribution center replaces the broadcast distribution signal received therein with that received by another distribution center in order of distribution centers A, B and C.

A channel map table is previously stored in the RAM 203 or the ROM 204 of each STB 40. Namely, a RAM 203 or a ROM 204 functions as a distribution plan storage to retain channel distribution plans, one representing distribution setting information of a broadcast distribution signal distributed from each distribution center.

Further, a STB 40 obtains the channel distribution plan of each shared digital center 10 through the CATV network (a first transmitting cable 16 and a second transmitting cable 13) at a predetermined timing of, for example, the change of the plan or at predetermined intervals and updates a channel map table using the obtained channel distribution plan. Thereby, a STB 40 always retains the latest channel distribution plans of shared digital centers 10.

Alternatively, the channel map tables shown in FIGS. 19(a) and 19(b), may be stored in a RAM 203 of each STB 40 when the STB 40 is installed in a subscriber home 12, or a STB 40 may obtain the channel distribution plan from each shared digital center 10 or local station 14 through a second transmitting cable 13 or the like each time when being activated, and may retain the obtained plans as a channel map table. Various alternatives and modifications of an obtaining manner and retaining of channel distribution plans can be suggested without departing from the scope of the present invention.

As an alternative obtaining manner, each head end (shared digital center 10 or a local station 14) may prepare a channel distribution plan thereof and a STB 40 may obtain a channel distribution plan from each head end through a first transmitting cable 16 and/or a second transmitting cable 13. As a further alternative, a STB 40 may connect to each shared digital center 10 or local station 14 through a public telephone line using a telephone modem 209 to obtain a channel distribution plan from each head end through the public telephone line. As a still alternative, each channel distribution plan may be stored in a medium exemplified by a flexible disc (FD), a CD-ROM, a CD-R, a CD-RW, a DVD, a DVD-R, a DVD-RW, a magnetic disc an optic-magnetic disc (MO), or a memory, and a STB 40 may obtain a channel distribution plan directly or indirectly from such a medium in any manner without departing from the concept of the present invention.

The receiving tuner 205 of each STB 40 checks a header of a Transport Stream (TS) included in a broadcast distribution signal that the receiving tuner 205 is receiving and specifies the head end which has created the broadcast distribution signal. The receiving tuner 205 therefore functions as a distribution center discrimination section for discriminating the distribution center which has created a broadcast distribution signal that is being received in the STB 40.

If a receiving tuner 205 discriminates that the upstream head end thereof has created a broadcast distribution signal being received in the receiving tuner 205, the receiving tuner 205 obtains NW-ID, TS-ID and NIT information in accordance with the channel map table concerning the upstream head end, shown in FIG. 19(b), and rapidly obtains video and audio streams corresponding to the selected program.

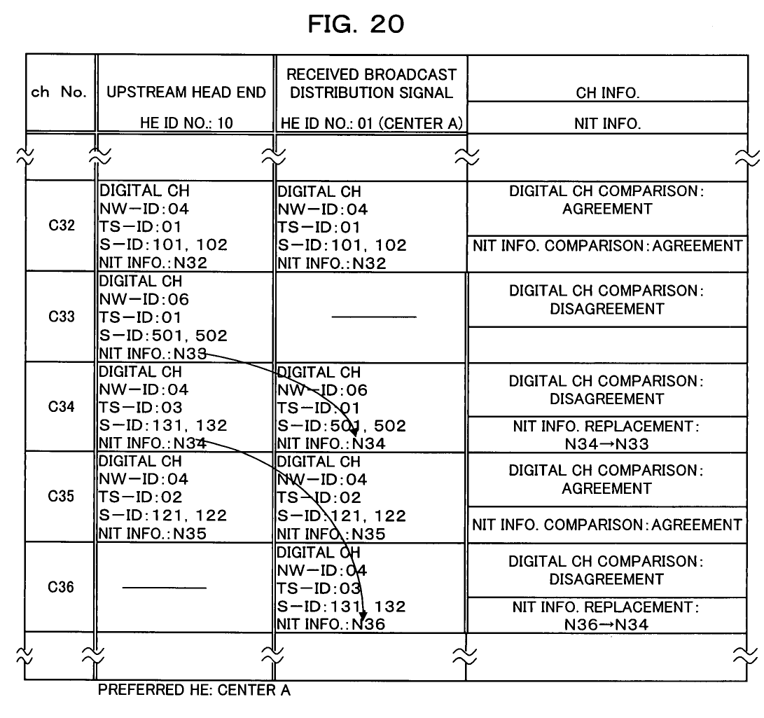

Conversely, if the receiving tuner 205 discriminates that a broadcast distribution signal received in the receiving tuner 205 has been created by a head end other than the upstream head end thereof, the receiving tuner 205 obtains a channel distribution plan of the broadcast distribution signal, which is being received, from the channel map table (FIG. 19(a)) and compares each channel in the obtained channel distribution plan with that included in the channel distribution plan of the upstream head end (FIG. 20). The receiving tuner 205 rewrites (changes) NIT information of a channel distribution plan piece included in the obtained channel distribution plan, which piece disagrees with the corresponding channel distribution plan piece of the upstream head end thereof, in accordance with the channel distribution plans of the upstream head end and the other distribution center so that the receiving tuner 205 receives the broadcast distribution signal.

Namely, a receiving tuner 205 functions as an NIT information changing section for changing, if a received broadcast distribution signal is discriminated to have been created in a distribution center other than the predetermined (upstream) distribution center thereof, NIT information of the received broadcast distribution signal on the basis of the channel distribution plan of the upstream shared digital center 10 and the other shared digital center 10s.

FIG. 20 shows a relationship between channel distribution plans of the upstream head end of a STB 40 and the broadcast distribution signal currently received in the STB in the digital broadcast signal distribution system 1.

A receiving tuner 205 compares the channel distribution plan of the upstream head end and the channel distribution plan of a currently-received broadcast distribution signal and receives the broadcast distribution signal concerning a channel having a channel distribution plan piece (ch. Info.) disagrees between the two plans, by changing NIT information included in the channel distribution plan of the currently-received broadcast distribution signal as a substitution for the corresponding NIT information of the upstream head end.

In the example of FIG. 20, a STB 40 receives a broadcast distribution signal distributed from (created in) the distribution center A (HE ID: 01) through the upstream head end. In this case, comparison of the channel distribution plan of the upstream head end with that of the distribution center A finds disagreements in channel distribution plan at channels C33 and C34.

For example, when a subscriber selects a program of S-ID=131 with a remote controller 118, the receiving tuner 205 of the STB 40 uses (changes) the NIT information, concerning channel C34, of the broadcast distribution signal (the broadcast distribution signal being received) from the distribution center A, as substitution for the corresponding information of the channel distribution plan of the upstream head end, based on the channel map table shown in FIG. 20.

Alternatively, the receiving tuner 205 may use the NIT information concerning channel C34 of the currently-received broadcast distribution signal as a substitution for the corresponding NIT information of the channel distribution plan of the distribution center.

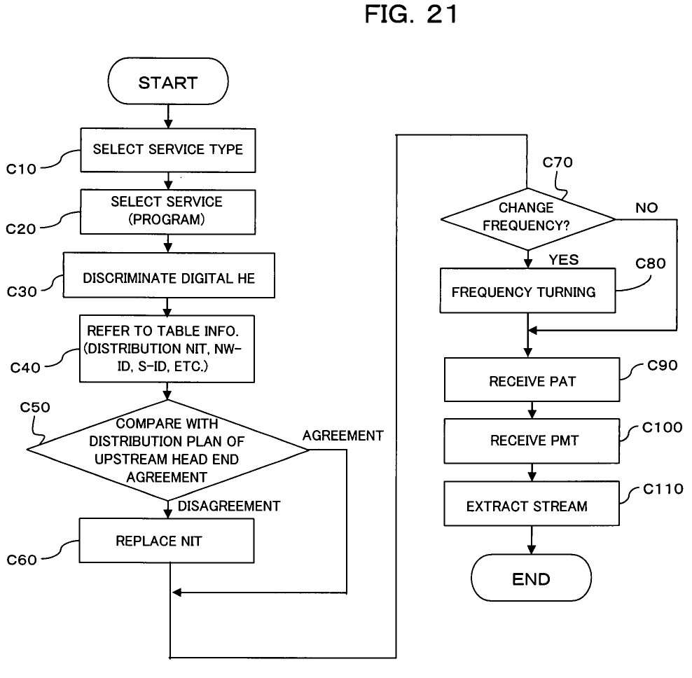

A succession of procedural steps to select a program at a STB 40 of the digital broadcast signal distribution system 1 will now be described with reference to flow diagram FIG. 21 (steps C10-C110).

First of all, a viewer (a subscriber) selects a service type (e.g., BS digital, CS digital) and service (a program to be viewed) with a remote controller 118 (steps C10 and C20). The receiving tuner 205 in the STB 40 discriminates a head end (a shared digital center 10 or a local station 14) that has been created and a distributed TS of a currently-received broadcast distribution signal based on the HE ID number of the signal (step C30).

The receiving tuner 205 refers to the channel map table stored in the RAM 203 or ROM 204, and further refers to channel distribution plans (channel distribution plan pieces: NIT information, NW-ID, and S-ID (see FIG. 19(a)) of the discriminated head end that distributes the currently-received broadcast distribution signal and the channel distribution plan (see FIG. 19(b)) of the upstream head end of the STB 40 (step C40). After that, the receiving tuner 205 compares the channel distribution plan pieces, concerning the selected channel (S-ID), of the discriminated head end and that of the upstream head end (step C50).

If the channel distribution plan piece of the discriminated head end disagrees with (is different from) that of the upstream head end (the “disagreement” route in step C50), the receiving tuner 205 replaces NIT information, corresponding to channel C34 of the upstream head, of the discriminated head end that has distributed the currently-received broadcast distribution signal end with the NIT information of C34 of the upstream head end (step C60).

The receiving tuner 205 determines, on the basis of the replaced NIT, whether or not the frequency of the currently-received broadcast distribution signal has to be changed or not in order to receive the selected program, in other words, whether or not the frequency of the stream being currently received is different from the frequency of a stream including the selected service (step C70). If a frequency change is not required (No route in step C70), the receiving tuner 205 obtains a PAT (Program Association Table) from the TS (step C90) and further obtains a PMT (Program Map Table) of the selected service from the obtained PAT (step C100). On the other hand, if a frequency change is required (Yes route in step C70), the receiving tuner 205 turns to the frequency including the selected service (step C80) and then proceeds to step C90.

The PMT designates PID (Packet

Identification) of streams of video, voice, data and the like of the selected service. The receiving tuner 205 therefore obtains PIDs of packets required to display the selected program on the basis of the contents of the PMT and filters the designated video stream and voice stream based on the PID to receive (extract) the streams (step C110). The video and voice streams are decoded and are displayed and sounded in a subscriber home 12.

As described above, in the digital broadcast signal distribution system 1, when a shared digital center 10 has poor reception of program information from a satellite, the shared digital center 10 selectively replaces (backs-up) a broadcast distribution signal created based on the program information received therein with a broadcast distribution signal, which has been created based on the program information in another shared digital center 10 and received through the backup line 15. Thereby, even when a distribution center has poor reception of program information from a satellite, it is possible for the distribution center to obtain program information high in quality and to provide subscribers downstream of the shared digital center 10 with high-quality program information.

A STB 40 retains channel map table (see FIG. 19(a)) including a channel distribution plan of each shared digital center 10 in digital broadcast signal distribution system 1 and discriminates a distribution center that has created a broadcast distribution signal currently received at the STB 40. If the discriminated distribution center is other than the predetermined (upstream) distribution center, the STB 40 changes NIT information of the broadcast distribution signal being received based on the channel distribution plans of the predetermined and the discriminated shared digital centers 10 and receives the broadcast distribution signal. Thereby, the STB 40 does not have to retrieve and obtain, as a program selection process, a TS based on the NIT, PMT, PAT and other information in order to extract video and voice streams and another stream associated with a designated service ID each time a subscriber selects a program whereupon a high-speed program selection process can be realized. Additionally, a shared digital center 10 and a local station 14 do not require a device to change NIT information and the digital broadcast signal distribution system 1 can be contracted at low cost.

Since a shared digital center 10 which receives a broadcast distribution signal from another shared digital center 10 through the backup line 15 and a local station 14 which receives the broadcast distribution signal distribute the received broadcast distribution signal to downstream subscribers without at least PSI/SI (Program Specific Information/Service Information), the shared digital center 10 and the local station 14 do not require a device to change PSI/SI and can be therefore realized at low cost. Further, a number of shared digital centers 10 in the digital broadcast signal distribution system 1 do not have to have a common channel distribution plan, so that the digital broadcast signal distribution system 1 can function with ease.

The RAM 203 or ROM 204 of each STB 40 retains a channel map table including channel distribution plans of shared digital centers 10 in the digital broadcast signal distribution system 1 in a rewritable form, so that the channel distribution plans can be updated when required, thereby improving convenience.

In particular, a STB 40 receives the channel distribution plans of each distribution center through the CATV network (a first transmitting cable 16 and/or a second transmitting cable 13) and updates the channel map tables using the received channel distribution plans so that the STB 40 advantageously retains the latest channel distribution plans with ease.

Since broadcast distribution signals (digital signals) are distributed to a subscriber home 12 and to a local station 14 from an upstream shared digital center 10 and to a subscriber home 12 from an upstream local station 14, the broadcast distribution signal does not deteriorate while being distributed so that subscriber homes 12 and local stations 14 can receive high-quality broadcast distribution signals.

It is possible to distribute a digital broadcast distribution signal to a distant subscriber home 12 from a shared digital center 10 by causing a local station 14, interposing between the subscriber home 12 and the shared digital center 10, to function as a repeater to relay the digital broadcast distribution signal.

Further, the backup line 15 that connects two or more shared digital centers 10 is a ring network, which can be easily realized. Even if an obstruction makes a part of the backup line 15 incapable of communication, communication can be continued using one or more shared digital centers 10 on the other side whereupon reliability of the communication line can be improved.

It is possible to set the latest channel distribution plans into a STB 40 by storing the channel distribution plans in the RAM 203 of the STB 40 when the STB 40 is installed at a subscriber home 12.

Two or more shared digital centers 10 distribute a broadcast distribution signal based on the same CATV channel allocation information, that is, the shared digital centers 10 have a common channel distribution plan. With such a manner, it is possible to enhance the quality of a signal received from a satellite, and a double or triple system functioning as a distribution centers station can be realized at minimum facility cost, i.e. at a low cost. In such a system, each entire shared digital center 10 does not have the entire broadcast distribution signal. For example, a shared digital center 10 is not allowed to retain a part of a broadcast distribution signal which part is retained by another shared digital center 10. At the same time, each STB 40 retains channel information common to a number of shared digital centers 10 and takes a shorter time to discriminate a shared digital center 10 that has created a broadcast distribution signal being received therein.

Further, the present invention should by no means be limited to the foregoing embodiment, and various changes or modifications may be suggested without departing from the gist of the invention.

For example, digital transmission is performed on broadcast distribution signals of the first embodiment when being sent and received in the digital broadcast signal distribution system 1, but a transmission manner should by no means be limited to digital transmission. Alternatively, broadcast distribution signals may be partially transmitted by analog transmission. Analog transmission does however generally tend to cause deterioration in signal quality over long distances, but analog transmission system has the advantage of being cheaper than digital transmission. Accordingly, digital transmission may be performed between a shared digital center 10 and a local station 14, serving as a repeater, and analog transmission may be performed between the local station 14 and subscriber homes 12. Such a transmission manner can facilitate construction of the digital broadcast signal distribution system at a low cost.

A STB (a distribution plan obtaining section) 40 may obtain channel distribution plans in various alternative manners. For example, a shared digital center 10 may distribute the channel distribution plan thereof in the form of an entitlement management message (EMM) or an entitlement control message (ECM) and a STB (a distribution plan obtaining section) 40 obtains the channel distribution plan from the ECM or the EMM. In this manner, each STB 40 can obtain the latest channel distribution plans and service to subscribers is improved.

Further, a STB (a distribution plan obtaining section) 40 may be communicably connected to a local station 14 and/or a shared digital center 10 using a telephone modem 209 through a public communication line and may obtain channel distribution plans through the public communication line. It is convenient because a STB 40 can obtain the latest channel distribution plans with ease. Especially, communication through a public communication line is generally low in communication speed but is excellent in communication quality, as compared with RF communication or the like, so that ensured distribution of channel distribution plans can be realized.

A channel distribution plan of each shared digital center 10 or local station 14 may be stored in a recording medium (e.g., a memory, a magnetic storage, a floppy (trademark) disc, a memory card, an optic-magnetic storage, a CD-ROM, a CD-R, a CD-RW, a DVD, a DVD-R, or a DVD-RW, etc.) and a STB 40 may include a recording medium reading section to read channel distribution plans from such a recording medium in which the channel distribution plans are stored. Alternatively, channel distribution plans may be set in a STB 40 when the STB 40 is installed in a subscriber home 12.

As still a further alternative, for example, a recording medium (e.g., a memory card, a smart card) may be inserted into a recording medium reading section (e.g., a card slot) included in a STB 40 and the STB 40 may read a channel map table (channel distribution plans) recorded in the recording medium. In this case, a medium may be inserted by a STB installer or by a subscriber that received a memory card by mail or together with the STB 40.

A STB 40 may include a communication interface to communicate with an external terminal such as a notebook PC and an installer (e.g., a CATV agency serviceperson) of the STB 40 may connect the STB 40 to the external terminal and set channel distribution plans in the STB 40.

A digital broadcast signal distribution system may include a subscriber management section for managing at least viewing state of subscribers. Such a subscriber management section executes access control in each local station 14, more specifically, manages STBs 40, access control, and charge concerning subscribers downstream thereof. A single distribution center may intensively function as a subscriber management section in the entire system or each local station 14 may individually function as a subscriber management section.

A subscriber management section centralized by a single distribution center makes the digital broadcast signal distribution system at a low cost and also reduces personnel cost due to requirement of a single call center that accepts complaints from subscribers. Further, the system can work efficiently.

Realization of subscriber management sections by individual local stations divides management work and therefore reduces burden on each subscriber management section. Especially, if each local station 14 manages a large number of subscriber homes 12, such burden division can effectively minimize influence caused by a system down in a single subscriber management section.

In the first embodiment, the provider distributes program information in the form of a satellite digital signal to distribution centers. Program information should by no means be limited to the form of a digital signal but alternatively, may be in the form of a ground digital signal. Other alternative program information can be suggested as long as it is within the scope of the present invention.

In the digital broadcast signal distribution system 1, a digital signal may be sent to local stations 14 from upstream shared digital centers 10 in an OFDM (Orthogonal Frequency Division Multiplexing) pass-through method. Generally, a digital signal is sent in the form of an OFDM modulation signal in order to avoid influence caused by radio wave interference. The signal form utilizes 6 MHz bandwidth identical to a bandwidth used in CATV transmission, can remain in an OFDM form while being sent in the system, and received in TV receivers conforming to ground digital signals.

Alternatively, each shared digital center 10 may send downstream local stations 14 a digital signal in a 64 QAM, so that a STB 40 installed at a subscriber home 12 can receive all digital broadcasting services of CS digital, BS digital and digital.

As a still further alternative, each shared digital center 10 may send downstream local stations 14 a satellite digital signal in QPSK (Quadrature Phase Shift Keying) or TC8PSK (Trellis-Coded eight PSK) method.

OOB (out-of-band) communication between each shared digital center 10 and downstream local stations 14 may utilize a common arrangement of physical channels whereupon it is possible for each shared digital center 10 to distribute information to subscriber terminals intensively utilizing OOB. In this case, management systems in individual shared digital centers 10 distribute map table lists to be used in downstream local stations 14 through the same physical channel.

Each shared digital center 10 may distribute channel distribution plans through a common physical channel, or each local station 14 may distribute channel distribution plans through a common physical channel.

Each local station 14 (an agency) may independently have an OOB distribution facility and distribution channel distribution plans (a channel map table) peculiar to individual agencies to downstream subscribers. In other words, each individual local station (agency) 14 may have a system for OOB distribution and may retain and manage channel distribution plans (a channel map table) in relation to programs to be distributed to downstream subscribers.

In order to discriminate a shared digital center 10 that has created a broadcast distribution signal being received, each STB 40 may have a function for decoding and recognizing a toll agency identification code, allocated to a distribution center, used in an access control system.

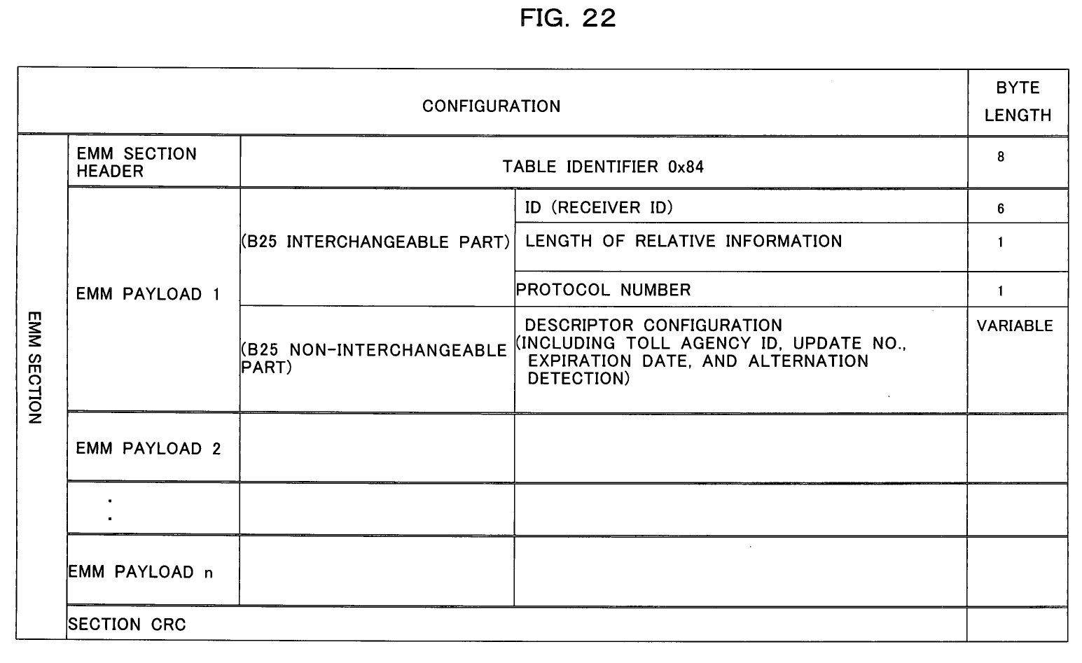

FIG. 22 shows an example of an EMM section format concerning BS access control, which format includes a toll agency identification code. A STB 40 may discriminate a shared digital center 10 that has created a broadcast distribution signal being received on the basis of a toll agency identification code included in an EMM section formation such as that shown in FIG. 22.

Alternatively, a STB 40 may discriminate a shared digital center 10 that has created a broadcast distribution signal being received based on agency codes, one allocated to each shared digital center 10 by a CA (Certification Authority). For example, in a remux system, the discrimination may be made on an agency code (a center ID code) in relation to conditional access that is information should be written into a CA card (a C-CA card) or a STB built-in CA chip.

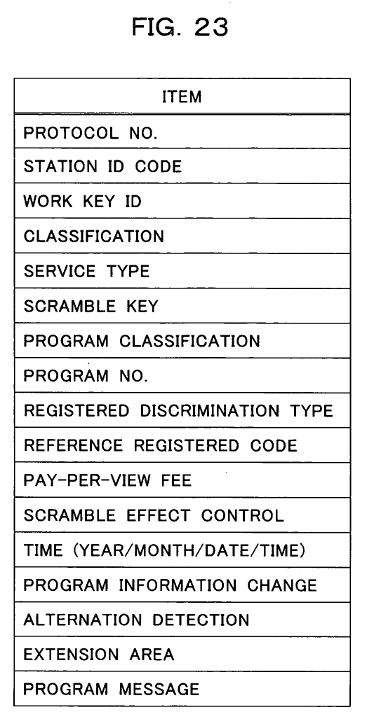

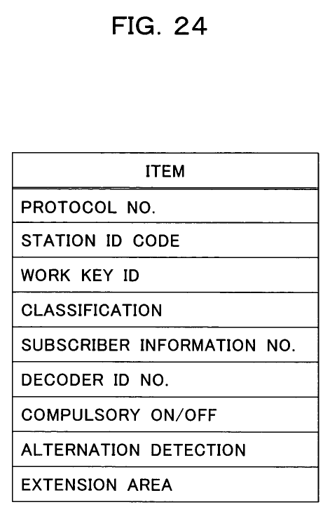

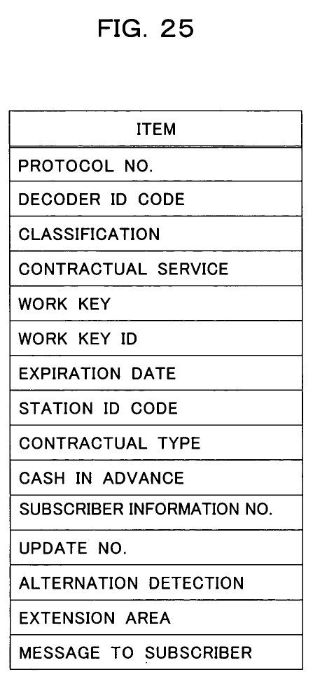

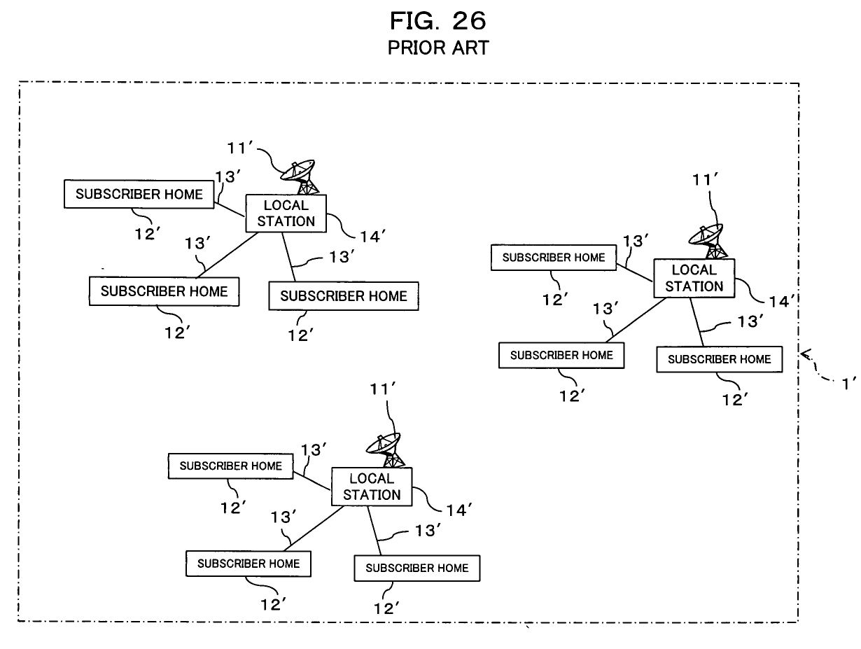

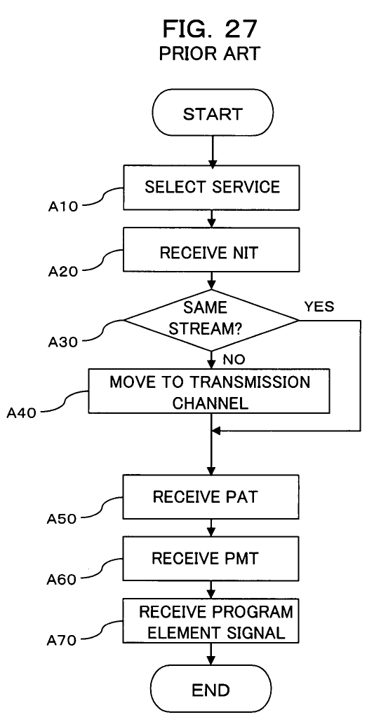

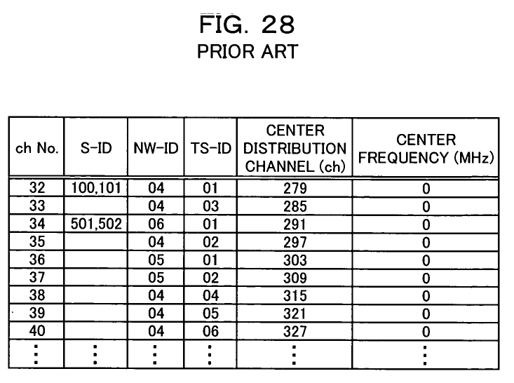

FIGS. 23, 24 and 25 respectively illustrate examples of information tables concerning an agency code for conditional access. FIG. 23 illustrates item examples of common information; FIG. 24 illustrates item examples of control information; and FIG. 25 illustrates item examples of individual information. An agency code (a center ID code) included in any one of these tables may be used for discrimination.

Further, a STB 40 may discriminate a shared digital center 10 that has created a broadcast distribution signal being received therein based on a broadcasting service type switching code (a network ID) or a S-ID (service ID) for a program selection, which code or ID is input by an operator (a subscriber) using a remote controller 118 or the like. Namely, a STB 40 can rapidly switch channels to ensure a quick response to a subscriber selection with discrimination means to discriminate, based on a broadcast service type switching code (a network ID) or a service ID (S-ID) for a program selection, which code or ID is input from a remote controller 118, that a received broadcast distribution signal is distributed in accordance with which channel distribution plan

What is claimed is:

1. A digital broadcast distribution signal distribution system comprising:
two or more distribution centers, communicably connected to one another through a communication line, each of said distribution centers for distributing a digital broadcast distribution signal, which has been created based on program information received in each said distribution center, to subscribers through a CATV (Community Antenna Television) network, for sending the digital broadcast distribution signal to another of said distribution centers and for receiving a digital broadcast distribution signal from another of said distribution centers; and
subscriber terminals, each for receiving a digital broadcast distribution signal distributed from one of the distribution centers through the CATV network so that a subscriber views a program,
each said distribution center including a signal replacement section for replacing the first-named digital broadcast distribution signal created based on the program information received in each said distribution center with the second-named digital broadcast distribution signal, which each said distribution center received from another of said distribution centers, and
each of said subscriber terminals including
a distribution plan storage for retaining channel distribution plans, one representing distribution setting information of the first-named digital broadcast distribution signal of each said distribution center,
a distribution center discriminating section for discriminating the one distribution center that has created the third-named digital broadcast distribution signal, which is received in each said subscriber terminal, and
a receiving section for changing, if the one distribution center is discriminated not to be a predetermined distribution center, NIT information of the third-named digital broadcast distribution signal based on the channel distribution plans of the one distribution center and the predetermined distribution center, and receiving the third-named digital broadcast distribution signal.

2. A digital broadcast signal distribution system according to claim 1, further comprising a local station, communicably connected to one of said distribution centers, for sending the third-digital broadcast distribution signal from the last-named one distribution center to subscribers downstream of said local station without changing at least PSI/SI (Program Specific Information/Service Information) of the third digital broadcast distribution signal.

3. A digital broadcast signal distribution system according to claim 1, wherein said signal replacement section in each said distribution center replaces the first-named digital broadcast distribution signal with the second-named digital broadcast distribution signal in accordance with a reception state of the first digital broadcast distribution signal at each said distribution center.

4. A digital broadcast signal distribution system according to claim 2, wherein said signal replacement section in each said distribution center replaces the first-named digital broadcast distribution signal with the second-named digital broadcast distribution signal in accordance with a reception state of the first digital broadcast distribution signal at said each distribution center.

5. A digital broadcast signal distribution system according to claim 1, wherein the CATV network includes an optical fiber through which the third-named digital broadcast distribution signal is distributed to each said subscriber terminal.

6. A digital broadcast signal distribution system according to claim 2, wherein the CATV network includes an optical fiber through which the third-named digital broadcast distribution signal is distributed to each said subscriber terminal.

7. A digital broadcast signal distribution system according to claim 3, wherein the CATV network includes an optical fiber through which the third-named digital broadcast distribution signal is distributed to each said subscriber terminal.

8. A digital broadcast signal distribution system according to claim 4, wherein the CATV network includes an optical fiber through which the third-named digital broadcast distribution signal is distributed to each said subscriber terminal.

9. A digital broadcast signal distribution system according to claim 5, wherein analog transmission is performed on the third-named broadcast distribution signal while being distributed to each said subscriber terminal in the CATV network.

10. A digital broadcast signal distribution system according to claim 6, wherein analog transmission is performed on the third-named broadcast distribution signal while being distributed to each said subscriber terminal in the CATV network.

11. A digital broadcast signal distribution system according to claim 7, wherein analog transmission is performed on the third-named broadcast distribution signal while being distributed to each said subscriber terminal in the CATV network.

12. A digital broadcast signal distribution system according to claim 8, wherein analog transmission is performed on the third-named broadcast distribution signal while being distributed to each said subscriber terminal in the CATV network.

13. A digital broadcast signal distribution system according to claim 1, further comprising a repeater for relaying the third-named digital broadcast distribution signal in the CATV network.

14. A digital broadcast signal distribution system according to claim 1, wherein the communication line that communicably connects said distribution centers is a ring network.

15. A digital broadcast signal distribution system according to claim 1, wherein the first-named digital broadcast distribution signal and the second-named digital broadcast distribution signal of each said distribution center are sent and received through the communication line via Internet Protocol (IP).

16. A digital broadcast signal distribution system according to claim 1, wherein the third-named digital broadcast distribution signal is distributed to each said subscriber terminal by using IP multicast.

17. A digital broadcast signal distribution system according to claim 1, wherein each said subscriber terminal further includes a distribution plan obtaining section for obtaining the channel distribution plans that are to be stored in said distribution plan storage.

18. A subscriber terminal for receiving a digital broadcast distribution signal from one of a plurality of distribution centers, each of which creates a digital broadcast distribution signal based on program information received from a provider, through a CATV (Community Antenna Television) network so that a subscriber views a program, said subscriber terminal comprising:
a distribution plan storage for retaining channel distribution plans, one representing distribution setting information of each of the plural distribution centers;
a distribution center discriminating section for discriminating the one distribution center that has created the first-named digital broadcast distribution signal received in said subscriber terminal; and
a receiving section for changing, if the one distribution center is discriminated not to be a predetermined distribution center, NIT information of the first-named digital broadcast distribution signal based on the channel distribution plans of the one distribution center and the predetermined distribution center, and receiving the first-named digital broadcast distribution signal.

19. A subscriber terminal according to claim 18, further including a distribution plan obtaining section for obtaining the channel distribution plans that are to be stored in said distribution plan storage.

20. A subscriber terminal according to claim 19, wherein said distribution plan obtaining section obtains the channel distribution plans through the CATV network.

21. A subscriber terminal according to claim 19, wherein:
each of the channel distribution plans is distributed in the form of an Entitlement Management Message (EMM) or an Entitlement Control Message (ECM); and
said distribution plan obtaining section obtains each of the channel distribution plans from the EMM or the ECM.

22. A subscriber terminal according to claim 20, wherein:
each of the channel distribution plans is distributed in the form of an Entitlement Management Message (EMM) or an Entitlement Control Message (ECM); and
said distribution plan obtaining section obtains each of the channel distribution plans from the EMM or the ECM.

23. A subscriber terminal according to claim 19, wherein said distribution plan obtaining section is communicably connected to a local station through a public communication line and obtains the channel distribution plans through the public communication line.

24. A subscriber terminal according to claim 19, wherein said distribution plan obtaining section is a recording medium reading section for reading the channel distribution plans from at least one recording medium in which the channel distribution plans are stored.

25. A subscriber terminal according to claim 18, wherein said distribution center discrimination section discriminates the one distribution center based on a toll agency identification code.

26. A subscriber terminal according to claim 18, wherein said distribution center discrimination section discriminates the one distribution center based on an agency code allocated by a Certification Authority (CA).

27. A subscriber terminal according to claim 18, wherein said distribution center discrimination section discriminates the one distribution center based on a broadcast service type switching code (a network ID) or a service ID (S-ID) for a program selection, which broadcast service type switching code or service ID is input by an operator.

28. A subscriber terminal according to claim 18, wherein, when said subscriber terminal is installed, the channel distribution plans are stored in said distribution plan storage.

29. A subscriber terminal according to claim 19, wherein, when said subscriber terminal is installed, the channel distribution plans are stored in said distribution plan storage.

30. A subscriber terminal according to claim 24, wherein, when said subscriber terminal is installed, the channel distribution plans are stored in said distribution plan storage.
